(19) United States
(12) Patent Application Publication
(10) Pub. No.: US 2009/0307255 A1
(43) Pub. Date: Dec. 10, 2009

(54) GRAPHICAL MANAGEMENT OF BUILDING DEVICES

(75) Inventor: Youngchoon Park, Brookfield, WI (US)

Correspondence Address: FOLEY & LARDNER LLP, 777 EAST WISCONSIN AVENUE, MILWAUKEE, WI, 53202-5306, US

(73) Assignee: Johnson Controls Technology Company

(21) Appl. No.: 12/135,043

(22) Filed: Jun. 6, 2008

(51) Int. Cl. G06F 17/30

(52) U.S. Cl. 707/102; 707/E17.005

(57) ABSTRACT

A system for processing user input received at a graphical user interface to configure a building device includes a processor and a first memory unit communicably coupled to the processor. The memory includes computer code for processing data relating to a floor plan and computer code for generating a graphical user interface, the graphical user interface including a representation of the floor plan. The memory further includes computer code for positioning an indicator relative to the graphical representation of the floor plan based on the user input, the indicator representing the building device. The memory also includes computer code for configuring the building device based on the position of the indicator relative to the graphical representation of the floor plan.

### BACKGROUND

The present disclosure generally relates to building systems such as building automation systems, fire systems, and security systems. The present disclosure relates more specifically to device management and configuration for a building system.

The setup and maintenance of building systems typically requires significant time and effort on behalf of building engineers. A large building can include hundreds of devices for heating, ventilation and air conditioning (HVAC) systems, fire systems, security systems, networking devices, and the like. Even if plans for installation are well laid out, devices are typically either named and tracked via manual data entry or based on physical network connections. Once installed, devices may be removed, moved, or replaced for maintenance activities, layout changes, or any number of other reasons. Even if organized, the administration of building devices typically relies heavily on manual data entry and its issues (e.g., human error, delay, inconsistency, etc.).

### SUMMARY

The invention relates to a system for processing user input received at a graphical user interface to configure a building device. The system includes a processor and a first memory unit communicably coupled to the processor. The memory includes computer code for processing data relating to a floor plan and computer code for generating a graphical user interface, the graphical user interface including a representation of the floor plan. The memory further includes computer code for positioning an indicator relative to the graphical representation of the floor plan based on the user input, the indicator representing the building device. The memory also includes computer code for configuring the building device based on the position of the indicator relative to the graphical representation of the floor plan.

The invention further relates to a system for processing user input at a graphical user interface to configure a building device of a building system. The graphical user interface includes a graphical representation of a building area and a graphical representation of the building device. The system includes a processing circuit configured to receive the user input and to analyze the spatial relationship between the graphical representation of the building area and the graphical representation of the building device, the processing circuit further configured to cause the update of data stored in memory of the building system and relating to the building device based on the spatial relationship analysis.

The invention further relates to a method for processing user input at a graphical user interface to configure a building device of a building system. The method includes the steps of processing data relating to a floor plan and generating a graphical user interface, the graphical user interface including a representation of the floor plan. The method further includes receiving the user input and positioning an indicator relative to the graphical representation of the floor plan based on the user input, the indicator representing the building device. The method yet further includes configuring the building device based on the position of the indicator relative to the graphical representation of the floor plan.

The invention further relates to a machine-readable medium for programming a computer to process user input received at a graphical user interface and for configuring a building device of a building system. The medium includes processor executable instructions for processing data relating to a floor plan, generating the graphical user interface, the graphical user interface including a representation of the floor plan, receiving the user input, positioning an indicator relative to the graphical representation of the floor plan based on the user input, the indicator representing the building device, and configuring the building device based on the position of the indicator relative to the graphical representation of the floor plan.

The invention further relates to a processing circuit configured to electronically transmit processor executable instructions via a communications interface. The processor executable instructions are for processing data relating to a floor plan, generating a graphical user interface, the graphical user interface including a representation of the floor plan, receiving the user input, positioning an indicator relative to the representation of the floor plan based on the user input, the indicator representing a building device, and configuring the building device based on the position of the indicator relative to the representation of the floor plan.

Alternative exemplary embodiments relate to other features and combinations of features as may be generally recited in the claims.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a perspective view of a building having a plurality of building devices, according to an exemplary embodiment;

FIG. 2A is a schematic diagram of a building automation system for the building of FIG. 1, according to an exemplary embodiment;

FIG. 2B is a block diagram of a security management system for the building of FIG. 1, according to an exemplary embodiment;

FIG. 2C is a block diagram of a fire alarm system for the building of FIG. 1, according to an exemplary embodiment;

FIG. 3 is a schematic diagram of a floor plan, according to an exemplary embodiment;

FIG. 4A is a perspective view of a graphical user interface (GUI) for graphical management of a building system, the GUI including a graphical representation of the floor plan shown in FIG. 3, according to an exemplary embodiment;

FIG. 4B is a flow diagram of a process for generating and receiving information from a GUI such as the GUI shown in FIG. 4A, according to an exemplary embodiment;

FIG. 5A is a block diagram of a device management system, according to an exemplary embodiment;

FIG. 5B is a block diagram of a device database of the device management system of FIG. 5A, according to an exemplary embodiment;

FIG. 5C is a block diagram of a configuration engine of the device management system of FIG. 5A, according to an exemplary embodiment;

FIG. 6 is a flow diagram of a process of adding a building device to a building area using a GUI and determining device properties, according to an exemplary embodiment;

FIG. 7 is a flow diagram of a process of determining and indexing spatial relationships using bounding contour data and location data for a building device, according to an exemplary embodiment;

FIG. 8 is a schematic diagram of a floor plan and a corresponding diagram of bounding contour data, according to an exemplary embodiment;

FIG. 9A is a flow diagram of a process of calculating a spatial relation between a building device and another building device or a building area, according to an exemplary embodiment;

FIG. 9B is an illustration of various types of spatial relations used by spatial relation functions of the present application, according to an exemplary embodiment;

FIG. 9C is a flow diagram of a process of calculating and using a spatial relation between a sensor and camera to configure the camera, the sensor, and/or a control system for the camera or the sensor, according to an exemplary embodiment;

FIG. 9D is a view of a floor plan including a sensor and camera and a bounding contour for the field of view for the camera, according to an exemplary embodiment;

FIG. 10 is a flow diagram of a process for naming a building device using spatial relation data generated by the systems and/or methods of the present disclosure, according to an exemplary embodiment;

FIG. 11 is a flow diagram of a process for generating an alarm using spatial relation data generated by the systems and/or methods of the present disclosure, according to an exemplary embodiment;

FIG. 12A is a schematic diagram of a floor plan, according to an exemplary embodiment;

FIG. 12B is a schematic view of an exemplary R-tree used to index data about the spatial relationships of the floor plan of FIG. 12;

FIG. 13 is an illustration of a table storing spatial relationship data, according to an exemplary embodiment;

FIG. 14A is a diagram of a building area, according to an exemplary embodiment;

FIG. 14B is a diagram of the building area of FIG. 14A, additionally illustrating a method of portioning the building area for searching, according to an exemplary embodiment;

FIG. 14C is a detailed view of the diagram and relevant points in FIG. 14A, according to an exemplary embodiment; and

FIG. 14D is a flow diagram of a process of querying using distance information, according to an exemplary embodiment.

### DETAILED DESCRIPTION OF THE EXEMPLARY EMBODIMENTS

Before turning to the figures which illustrate the exemplary embodiments in detail, it should be understood that the application is not limited to the details or methodology set forth in the description or illustrated in the figures. It should also be understood that the terminology is for the purpose of description only and should not be regarded as limiting.

According to one exemplary embodiment, a computer system is provided for generating a graphical user interface for viewing by a user and for receiving user input from the user. The graphical user interface includes a graphical representation of a floor plan that has been created based on pre-existing computer-aided design file(s) of the floor plan. The system is configured to provide indicators of building devices (e.g., icons, polygons, line art, etc.) for placing onto the graphical representation of the floor plan. The system is further configured to use calculated relationships between the indicators and the floor plan to configure the building devices.

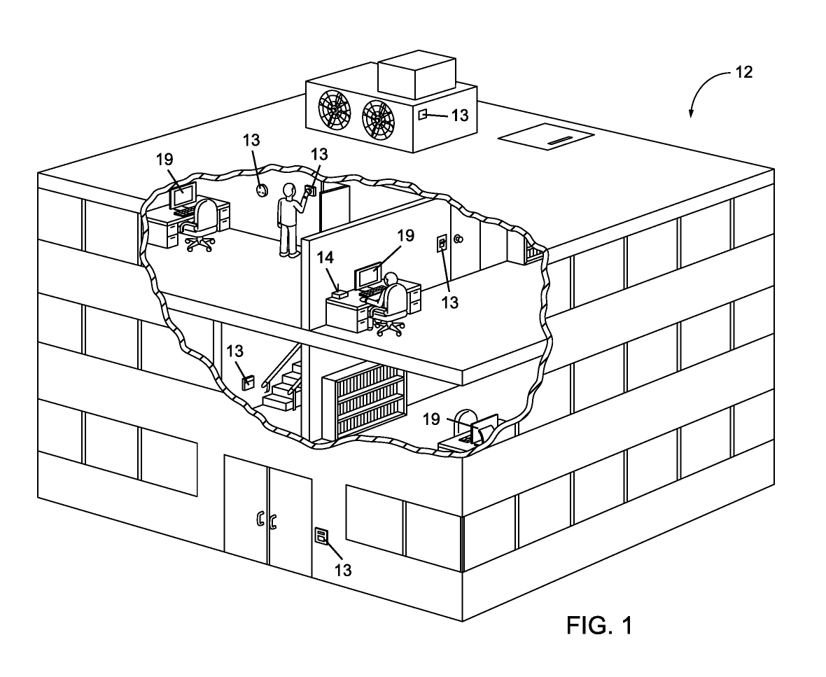

FIG. 1 is a perspective view of a building 12 having a plurality of building devices 13, according to an exemplary embodiment. As illustrated, building 12 may include any number of floors, rooms, spaces, zones, and/or other building structures and areas. According to various exemplary embodiments, building 12 may be any area of any size or type, including an outdoor area. Building devices 13 may exist inside or outside the building, on walls or on desks, be user interactive or not, and may be any type of device. For example, building devices 13 may be a security device, a light switch, a fan actuator, a temperature sensor, a thermostat, a smoke detector, an occupancy sensor, other various types of sensors (flow, pressure, etc.), etc. Building devices 13 may be configured to conduct building automation functions (e.g., sense temperature, sense humidity, control a building automation device, etc.). Building devices 13 may also serve any number of network functions (e.g., network routing functions, etc.). A controller system 14 is shown as a desktop device. A workstation 19 is shown as a personal workstation. Workstation 19 may allow building engineers to interact with controller system 14 and/or building devices 13. Building devices 13 may be connected to controller system 14 and/or workstations 19 via a wired and/or wireless connection.

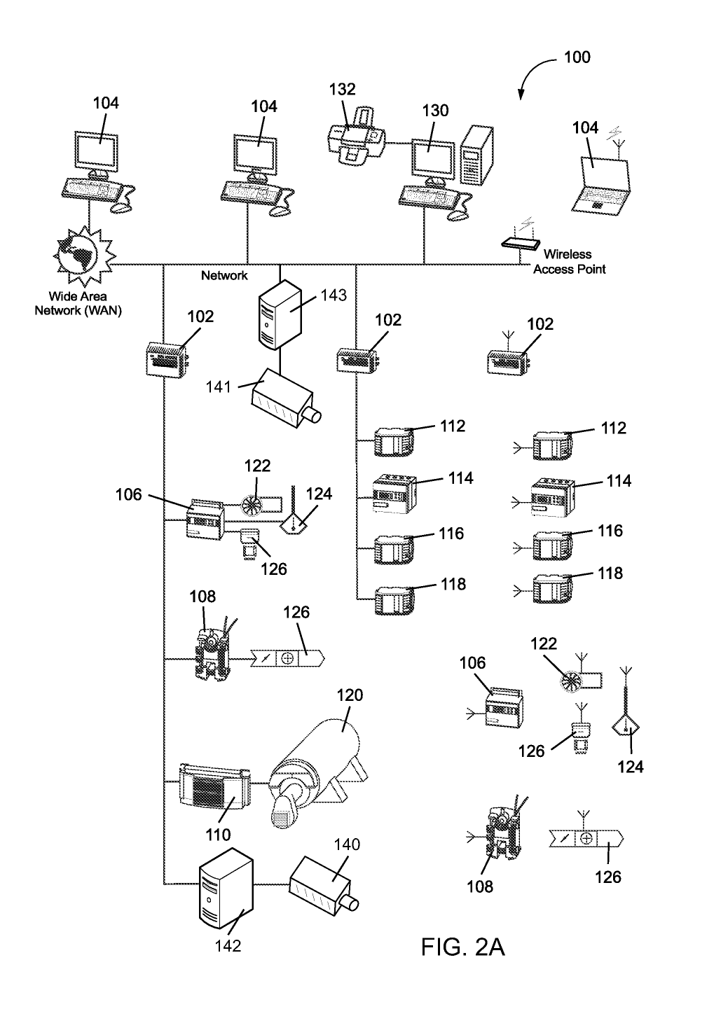

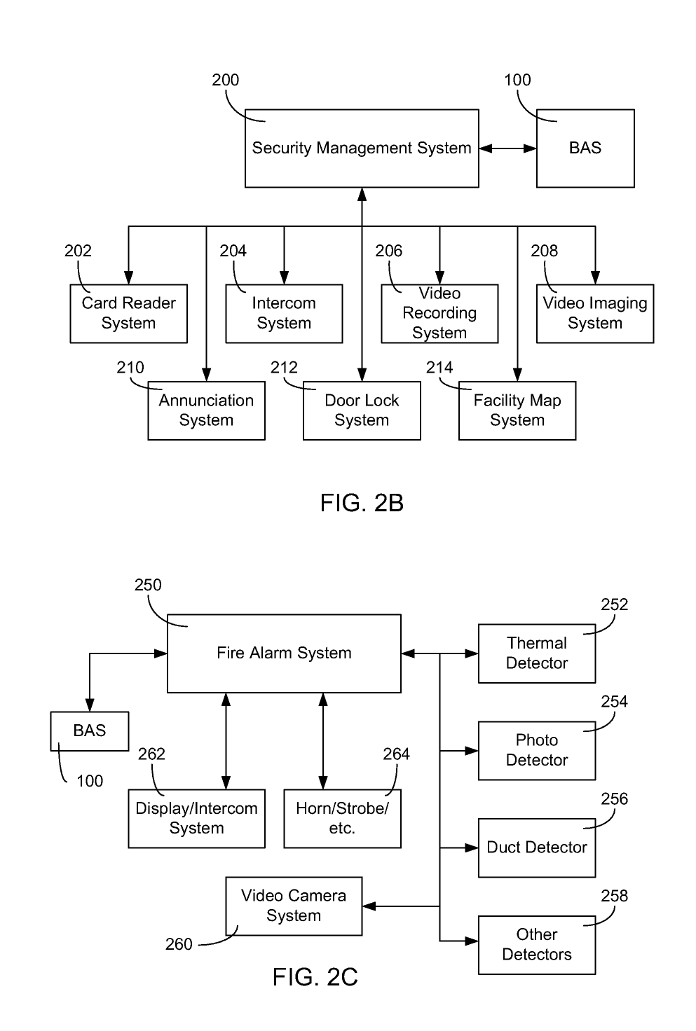

Building automation systems (BAS) are, in general, hardware and/or software systems configured to control, monitor, and manage equipment in or around a building or building area. BAS equipment can include a heating, ventilation, and air conditioning (HVAC) equipment, an elevator system, another system that is capable of managing building functions, or any combination thereof. The BAS as illustrated and discussed in FIG. 2A is an example of a building system that may be used in conjunction with the systems and methods of the present disclosure; however, other building systems may be used as well. FIGS. 2B and 2C illustrate a security system and a fire alarm system that may be used in conjunction with the systems and methods of the present disclosure. For example, the various devices shown in FIGS. 2A-C may be the building devices referenced throughout the present disclosure. According to other exemplary embodiments, the systems and methods of the present disclosure may be used in conjunction with any type of system (e.g., a communications system, a video system, a sensor system, a manufacturing system, etc.).

Referring to FIG. 2A, a schematic diagram of a BAS 100 that may be used with the systems and methods of the present disclosure is shown, according to an exemplary embodiment. BAS 100 may include one or more supervisory controllers (e.g., a network automation engine (NAE)) 102 connected to a proprietary or standard communications network such as an IP network (e.g., Ethernet, WiFi, ZigBee, Bluetooth, etc.). Supervisory controllers 102 may support various field-level communications protocols and/or technology, including various Internet Protocols (IP), BACnet over IP, BACnet Master-Slave/Token-Passing (MS/TP), N2 Bus, N2 over Ethernet, Wireless N2, LonWorks, ZigBee, and any number of other standard or proprietary field-level building management protocols and/or technologies. Supervisory controllers 102 may include varying levels of supervisory features and building management features. The user interface of supervisory controllers 102 may be accessed via terminals 104 (e.g., web browser terminals) capable of communicably connecting to and accessing supervisory controllers 102. For example, FIG. 2A shows multiple terminals 104 that may variously connect to supervisory controllers 102 or other devices of BAS 100. For example, terminals 104 may access BAS 100 and connected supervisory controllers 102 via a WAN, an Internet location, a local IP network, or via a connected wireless access point. Terminals 104 may also access BAS 100 and connected supervisory controllers 102 to provide information to another source, such as printer 132.

Supervisory controllers 102 may be connected to any number of BAS devices. The devices may include, among other devices, devices such as field equipment controllers (FEC) 106 and 110 such as field-level control modules, variable air volume modular assemblies (VMAs) 108, integrator units, room controllers 112 (e.g., a variable air volume (VAV) device or unit), other controllers 114, unitary devices 116, zone controllers 118 (e.g., an air handling unit (AHU) controller), boilers 120, fan coil units 122, heat pump units 124, unit ventilators 126, expansion modules, blowers, temperature sensors, flow transducers, other sensors, motion detectors, actuators, dampers, heaters, air conditioning units, etc. These devices may generally be controlled and/or monitored by supervisory controllers 102. Data generated by or available on the various devices that are directly or indirectly connected to supervisory controller 102 may be passed, sent, requested, or read by supervisory controller 102 and/or sent to various other systems or terminals 104 of BAS 100. The data may be stored by supervisory controller 102, processed by supervisory controller 102, transformed by supervisory controller 102, and/or sent to various other systems or terminals 104 of the BAS 100. As shown in FIG. 2A, the various devices of BAS 100 may be connected to supervisory controller 102 with a wired connection or with a wireless connection.

Still referring to FIG. 2A, an enterprise server 130 (e.g., an application and data server (ADS)) is shown, according to an exemplary embodiment. Enterprise server 130 is a server system that includes a database management system (e.g., a relational database management system, Microsoft SQL Server, SQL Server Express, etc.) and server software (e.g., web server software, application server software, virtual machine runtime environments, etc.) that provide access to data and route commands to BAS 100. For example, enterprise server 130 may serve user interface applications. Enterprise server 130 may also serve applications such as Java applications, messaging applications, trending applications, database applications, etc. Enterprise server 130 may store trend data, audit trail messages, alarm messages, event messages, contact information, and/or any number of BAS-related data. Terminals may connect to enterprise server 130 to access the entire BAS 100 and historical data, trend data, alarm data, operator transactions, and any other data associated with BAS 100, its components, or applications. Various local devices such as printer 132 may be attached to components of BAS 100 such as enterprise server 130.

Still referring to FIG. 2A, BAS 100 may include one or more video cameras 140, 141 and associated video processing system hardware 142, 143. According to one exemplary embodiment, camera 140 and video processing system hardware 142 may be connected to a general purpose network. According to another exemplary embodiment, camera 141 and video processing system hardware 143 may be connected to supervisory controller 102. Video cameras 140, 141 may be used for surveillance and security purposes, entertainment purposes, scientific purposes, or any other purpose. The environment in which cameras 140, 141 are positioned to capture video from may include any number of persons, spaces, zones, rooms, and/or any other object or area that may be either stationary or mobile. Video cameras 140, 141 may be analog or digital cameras and may contain varying levels of video storage and video processing capabilities. Video cameras 140, 141 may be communicably coupled to video processing system hardware 142, 143. Video processing system hardware 142, 143 may receive input from a single camera 140, 141 or a plurality of video cameras and conduct a variety of processing tasks based on data received. The communication connection between cameras 140, 141 and hardware 142, 143 may be wired, wireless, analog, digital, internet protocol-based, or use any other suitable communications systems, methods, or protocols. Cameras 140, 141 and hardware 142, 143 may be communicably connected to BAS 100 in a variety of ways (e.g., via a BAS communications bus, via a building LAN, WAN, Ethernet connection, etc., via a wireless connection, via a dedicated video bus, etc.).

Referring to FIG. 2B, a block diagram of a security management system is shown, according to an exemplary embodiment. Security management system 200 may be a system configured to provide various security functions for a building area. Security management system 200 may be coupled to a BAS 100 and provide data and/or commands for the various devices of BAS 100.

Various security systems may be coupled to security management system 200. For example, card reader system 202 is coupled to system 200. Card reader system 202 may include a scanner for scanning identification cards and allowing or disallowing a person or object associated with the identification card into an area. Intercom system 204 is coupled to system 200 and may be used to audibly provide security information and messages to a building area.

Video recording system 206 is coupled to system 200 and may be used to record events in the building area. Video recording system 206 may include multiple cameras located in a building area that may be used together to record any detected or desired events. Similarly, video imaging system 208 is coupled to system 200 and may be used to record frames or pictures captured using the cameras.

Annunciation system 210 is coupled to system 200 and may be used to provide an alarm, either audibly or visually, for users of the building area if a situation arises. Door lock system 212 is coupled to system 200 and may be used to secure and lock doors, windows, or other objects of a building area. Facility map system 214 is coupled to system 200 and may be used to generate a graphical view of the building for a user. Facility map system 214 may be configured to provide a display for each of the systems coupled to system 200, according to an exemplary embodiment.

Referring to FIG. 2C, a block diagram of a fire alarm system is shown, according to an exemplary embodiment. Fire alarm system 250 may be a system configured to detect a fire and to provide an alarm based on the fire detection. Fire alarm system 250 may be coupled to BAS 100 and provide data and/or commands for the various devices of BAS 100.

Fire alarm system 250 is coupled to various detectors that may be used to determine if a fire is present. For example, thermal detector 252, photo detector 254, duct detector 256, and other detectors 258 may be used to detect fire conditions. Additionally, video camera system 260 is coupled to fire alarm system 250 and may be used to visually analyze a building area such that a user may view a potential fire hazard. Video camera system 260 may additionally record any unique events which may be a potential fire hazard event.

Display/intercom system 262 is coupled to system 250 and may receive an input from system 250 regarding a fire alarm. Display/intercom system 262 may provide the appropriate output for users of the building area. Additionally, a horn or strobe 264 may be coupled to system 250 and may activate via a signal from system 250.

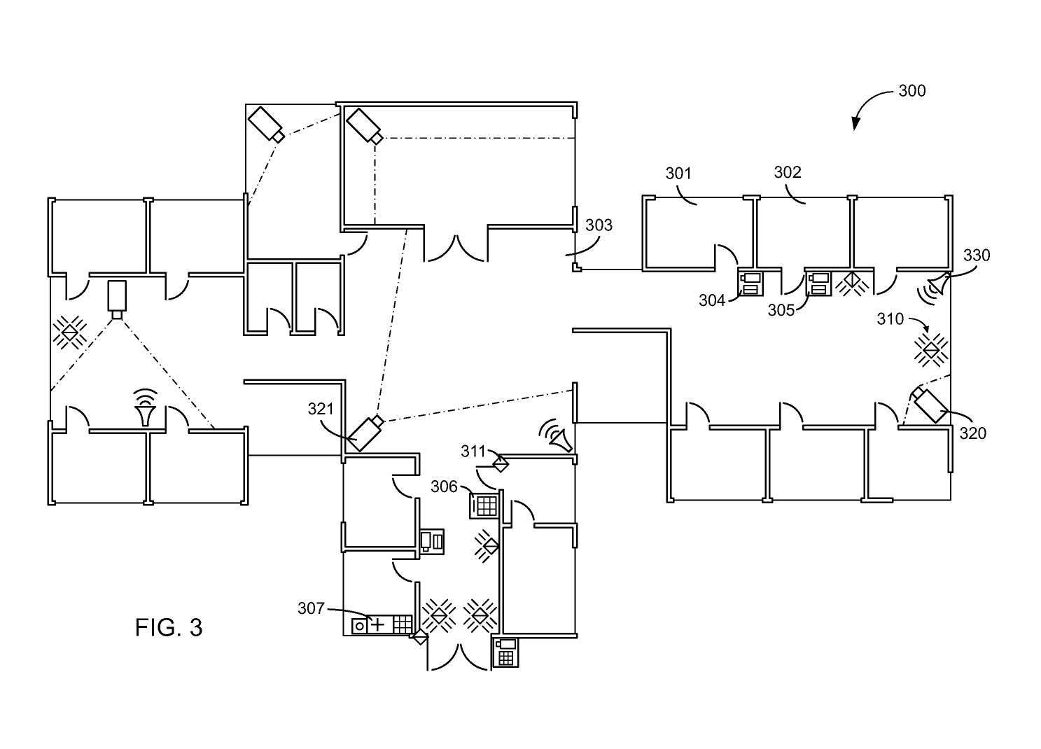

Referring to FIG. 3, a floor plan 300 is shown, according to an exemplary embodiment. Floor plan 300 is an example of a schematic view that may be provided to a user for graphical management of devices for a building area or zone. Floor plan 300 may be used, in conjunction with other stored data regarding the building area and its components and logic for determining relationships, to assign spatial relations between areas, devices, sensors, cameras, and alarms. According to other exemplary embodiments, other maps or views may be generated in place of floor plan 300.

Floor plan 300 illustrates multiple areas of a building area or zone. For example, two areas 301, 302 are shown. An area may be surrounded by walls or not, may or may not include a door or to open or close the area, and may include or be associated with any number of devices, sensors, cameras, and alarms. For example, a building device 304 is shown adjacent to area 301, building device 305 is shown adjacent to area 302, sensor 310 may be a motion sensor detecting activity around areas 301, 302, camera 320 may be configured to record events occurring around areas 301, 302, and alarm 330 may function as an alarm for people in areas 301, 302 in case of an emergency.

Floor plan 300 illustrates various building devices throughout the floor plan. For example, building devices 304, 305 may be a card reader and camera device. Card reader and camera device 304, 305 may be used to restrict access to areas 301, 302 and to record activity around devices 304, 305. Building device 306 is shown as a card reader device without a camera. According to various exemplary embodiments, the card reader devices may include a keypad. Other building devices such as building device 307 may be a video keyboard, a pushbutton, or other device.

Floor plan 300 additionally illustrates various sensors throughout the floor plan. For example, sensor 310 is shown near areas 301, 302, and may be a motion sensor configured to detect motion in and around areas 301, 302. A motion sensor may be placed in the floor of the building area or on a wall of a building area. Sensor 311 is shown as a door contact sensor configured to detect object contact with the door. Other sensors may be placed throughout the building area and may include temperature sensors, humidity sensors, motion sensors, contact sensors, occupancy sensors, etc.

Floor plan 300 additionally illustrates multiple cameras. For example, camera 320 is illustrated as being able to view areas 301, 302 among other areas of floor plan 300. Cameras may be either rotating (e.g., camera 320, whose sight lines are wide) or in a fixed position (e.g., camera 321 is unable to completely cover all of area 303 since the camera may not be able to rotate). Cameras may be associated with nearby devices, sensors, or alarms (e.g., camera 320 may be associated with building devices 304, 305, sensor 310, and alarm 330).

Floor plan 300 additionally illustrates multiple alarms. For example, alarm 330 is illustrated near areas 301, 302, and may issue an alarm relating to a special condition with areas 301, 302 (e.g., if building devices 304, 305, sensor 310, and/or camera 320 detect a special condition). Alarms may be a horn, siren, or other device used to emit a loud sound, a light configured to flash or alert a user, etc.

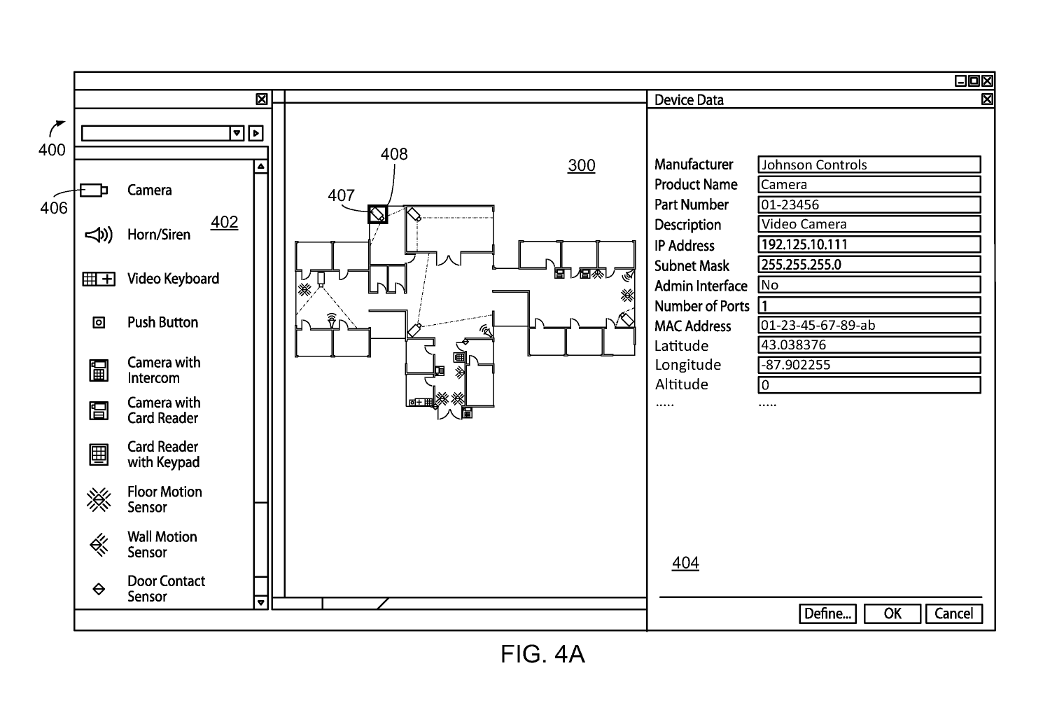

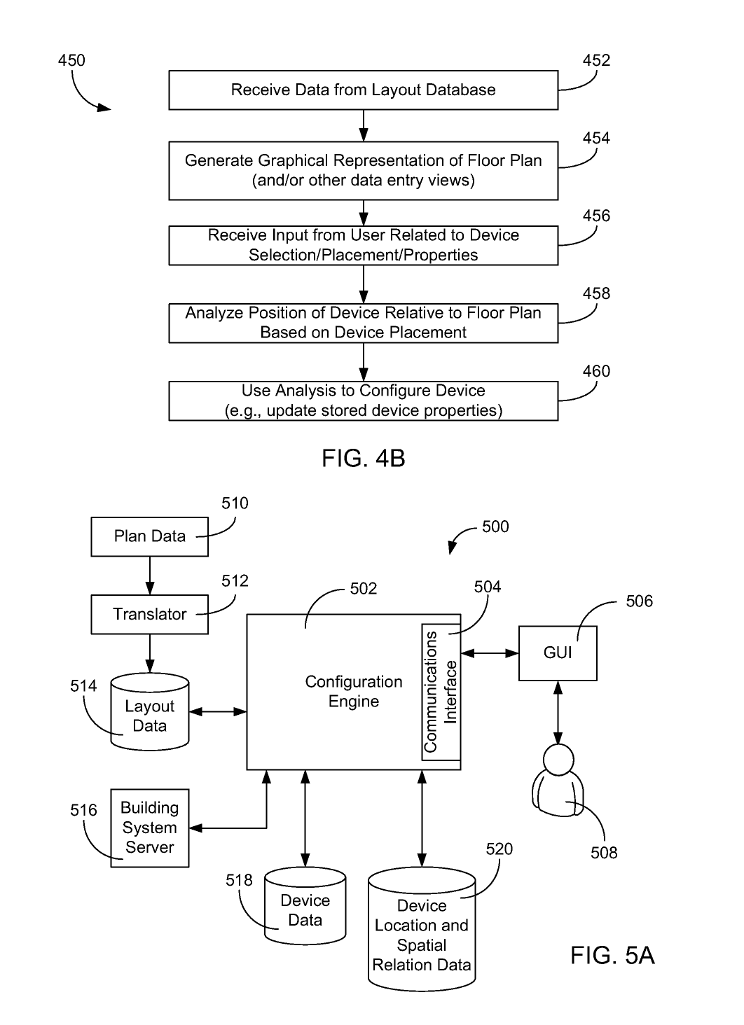

Referring to FIG. 4A, a graphical user interface (GUI) 400 that may be used to maintain building devices is shown, according to an exemplary embodiment. A user may interact with GUI 400 to add, delete, and/or edit devices and areas of a building area. GUI 400 is shown to include a display of floor plan 300. Using GUI 400, a user may edit the location of devices, sensors, cameras, and/or alarms for the building area by editing floor plan 300. Additionally, a user may use GUI 400 to place building devices, sensors, cameras, etc., on floor plan 300. GUI 400 may allow a user to set locations where various building devices such as sensors, cameras, and/or alarms should be installed (or are installed) within the building area.

On floor plan 300, various device indicators are shown to represent the various building devices of the building area. For example, device indicator 407 illustrates a camera. Device indicator 407 may be an image or other representative shape chosen by GUI 400 (or a user thereof) to represent an object in the building area. GUI 400 may be configured such that the user may edit the location and other properties of the object via editing (e.g., moving, resizing, rotating, stretching, etc.) device indicator 407 relative to floor plan 300. A bounding contour 408 for the building device represented by device indicator 407 is shown. Bounding contour 408 may a tool for moving, resizing, placing, aligning, or otherwise editing the location of the device indicator 407 relative to the floor plan 300. Bounding contour 408 may represent an approximate amount of space the building device takes up, the space over which the building device may operate if the device is a sensor, or may represent other sizes or orientations. According to one exemplary embodiment, a user may edit bounding contour 408 and device indicator 407 (e.g., the size, shape, location, and/or orientation thereof), allowing the user to manually edit the building device properties relative to its representative area. According to another exemplary embodiment, bounding contour 408 may be a predetermined area for the building device and not editable.

GUI 400 may include a panel (or other GUI tool) 402 for component selection, according to an exemplary embodiment. A user may “drag and drop” a device indicator (e.g., any device, sensor, etc.) from panel 402 to floor plan 300. For example, device indicator 406 for a camera may be selected by a user and placed on floor plan 300.

According to an exemplary embodiment, panel 402 may be populated with device indicators based on bill of materials (BOM) information. A BOM may include information about the building devices and components ordered and/or initially planned for the building area. For example, a building planner may have ordered ten of a particular type of camera. This order may be reflected in a BOM stored in and/or accessible by the system. The system may be configured to then read the BOM and to populate panel 402. Because the BOM will include device model numbers and/or other identifying information, when the devices are moved from panel 402 to floor plan 300 via GUI 400, many of the fields of device data 404 may automatically be populated by the system. The system may be configured to add to the BOM if the user selects devices for floor plan 300 that are not initially in the BOM. The system may then be configured to communicate with an ordering system (e.g., via a business to business communications interface) so that the additional devices are automatically ordered.

GUI panel 404 may provide an interface for a user to manually enter, edit, or view information about a building device, sensor, or area shown on floor plan 300. For example, for a building device, information such as manufacturer and product name, part number, and description may be entered or edited and stored. Further, network information for the building device if the building device is online (e.g., IP address, subnet mask, if the building device access is restricted to an administration interface, the number of ports, MAC address, etc.) may be populated, viewed, entered, edited, and/or viewed. Building device location information (e.g., latitude, longitude, altitude, etc.) may be browsed or edited (e.g., the user may change or refine the location of a building device in floor plan 300 by entering new data in panel 404). The information may be stored in a database and/or used by the device management system to assign spatial relations or for another purpose.

Referring now to FIG. 4B, a flow diagram of a process 450 for updating building device information is shown, according to an exemplary embodiment. Process 450 is shown to include the step of receiving data from a layout database (step 452). The data from the layout database may be received at a GUI engine or another processing module. Process 450 is further shown to include using the data from the layout database to generate a floor plan view (and/or other applicable view) for a user of the GUI (step 454). For example, a panel and functionality for adding new building devices to the building area or zone may be provided (e.g., panel 402). The GUI may generate any number of views (or other GUI elements—e.g., dialog boxes, tabbed elements, buttons, etc.) configured to receive input from a user regarding the location and/or other properties of building devices. The views may be used to edit existing information about the building devices, other components, or areas of the building area or zone, add new information, configure the location and/or functionality of building devices or other components in the building area or zone, etc.

User input may be received at the GUI (step 456). The input may pertain to a building device selection (e.g., the addition of a new building device to the floor plan), a building device placement (e.g., the location of a new building device or a change in location of an already existing device) or building device properties (e.g., a change or addition to one or more building device properties). According to an exemplary embodiment, the user input includes positioning an indicator (e.g., icon, polygon, bounding contour around, a point, etc.) representing the building device on a graphical representation of the floor plan.

Process 450 is shown to include the step of analyzing the position of the building device relative to the floor plan based on building device placement (step 458). Step 458 may further include analyzing the position of the building device relative to other building devices. Step 458 may include analyzing the spatial relationship between points and/or lines of the floor plan relative to the shape (e.g., polygon, drawing contour, lines) of the indicator. According to an exemplary embodiment, data from the analysis is then used to configure the building device (step 460). Configuring the building device may include updating stored building device properties in one or more systems or databases (e.g., a building automation system, a security system, a fire system, etc.). Data from the analysis may be stored and/or used in other methods and systems of the device management system (e.g., used in intermediate calculations, stored in a temporary database, stored in temporary memory, stored in memory local and/or remote to the device management system, etc.).

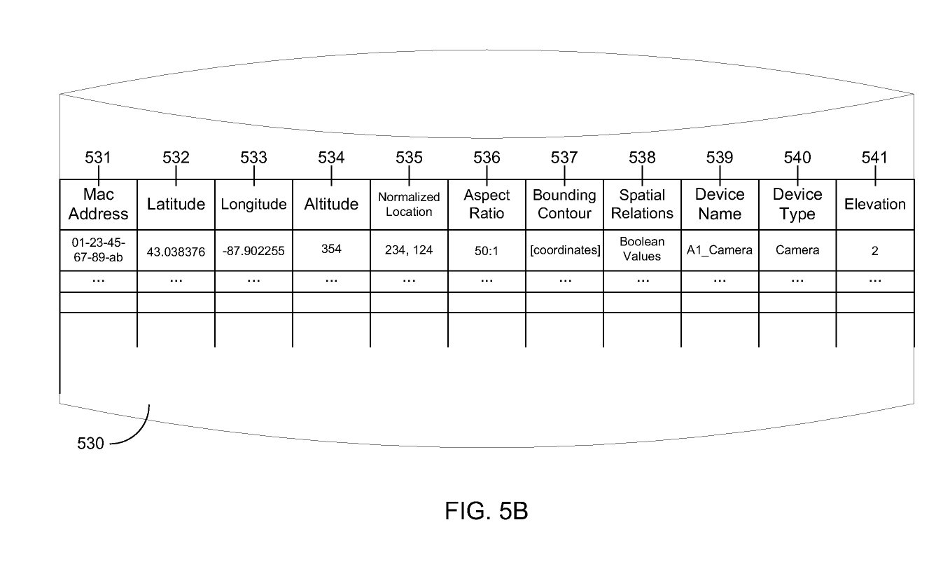

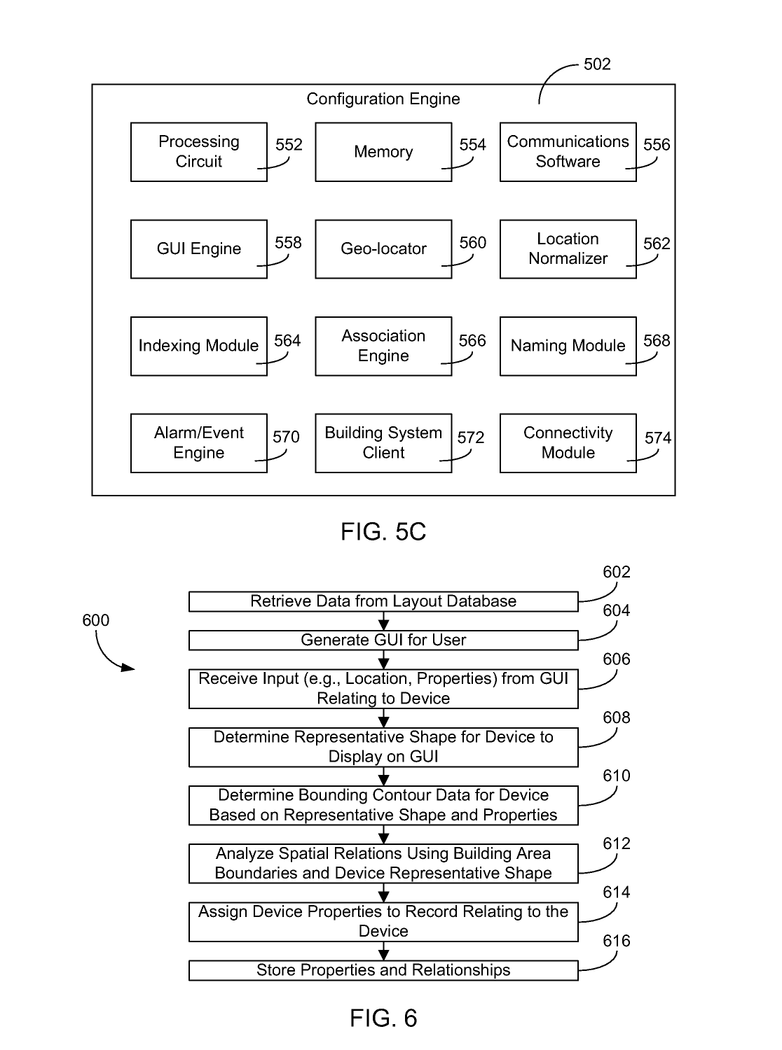

Referring to FIG. 5A, a block diagram of a device management system 500 is shown, according to an exemplary embodiment. A configuration engine 502 (e.g., an authoring tool) is shown coupled to various data storage components and other components of device management system 500. Configuration engine 502 includes communications interface 504. Communications interface 504 may be a jack, terminal, device driver, processing circuitry or otherwise configured to interface with a display module or another client device configured to generate a GUI 506 (including, for example, GUI 400 shown in FIG. 4A). GUI 506 may be provided as a user interface for a user 508 of the building area and device management system 500.

Plan data 510 may be data relating to the size, shape, structure, and other properties of the building area and of each area within the building area. According to an exemplary embodiment, plan data is computer-aided design or blueprint drafting data and/or files used in the construction of the building space and/or in installation of services for the building space (e.g., electrical wiring, HVAC installation, etc.). According to various alternative embodiments, plan data 510 may be in an image format (e.g., JPG, GIF, BMP, etc.) or a format usable in diagramming software. According to an exemplary embodiment, plan data 510 is a pre-existing file or files including coordinate data used to describe a floor plan. According to various exemplary embodiments, the floor plan and/or plan data 510 may be two dimensional, two-point-five dimensional, pseudo-three dimensional, and/or three dimensional data.

Device management system 500 is shown to include a translator 512 that is configured to receive (and/or access and read) plan data 510 and to convert plan data 510 into data for device management system 500 (e.g., format-neutral metadata, XML data, object data, propriety data of a type defined by device management system, etc.). In addition to conversion activities, translator 512 may analyze the plan data to generate a scale for the floor plan, bounding polygon (or bounding lines that do not form polygons) for areas and objects of the floor plan (e.g., a bounding polygon for each room), the resolution of the floor plan, the world coordinates (e.g., GPS coordinates, altitude, longitude, elevation, etc.) for the floor plan and/or objects in the floor plan, normalized coordinates of the floor plan, and the like. The metadata, transformed plan data, and/or calculated plan data may be stored in layout database 514 for use by configuration engine 502 (e.g., to generate GUI 506).

According to one exemplary embodiment, translator 512 is an electronic drawing reader. Translator 512 may be a single or multi-format map and/or image decoder. According to an exemplary embodiment, translator 512 is configured to accept a drawing in a variety of formats (e.g., an image or images, a .VSD file, an AutoCAD format, etc.), according to one exemplary embodiment. Translator 512 may be a computing system separate from configuration engine 502, integral with configuration engine 502, computer code residing in memory of configuration engine 502, or otherwise. According to an alternative embodiment, translator 512 includes a scanner, software for the scanner, object recognition software, and additional computer code for conducting the translation activities described above.

Building system server 516 is coupled to configuration engine 502. Building system server 516 may be communicably coupled to the various building devices and components of the building system (e.g., as shown in FIGS. 2A-2C). Building system server 516 may receive data from the building devices of the building system and provide the data to configuration engine 502 for use by device management system 500. Building system server 516 may also store data from the building devices of the building system and/or receive data from device management system 500 for storage. Building system server 516 may additionally send data from device management system 500 to individual building devices or other components of the building system.

Device database 518 and device location and spatial relation database 520 are shown as coupled to configuration engine 502. Device database 518 may generally store device properties, geolocation properties, bounding contour properties, and other building device data. Device location and spatial relation database 520 may generally store derived information about the building device, such as a normalized location (calculated using the geolocation properties), spatial relations between the building device and other building devices and areas (calculated using the bounding contour properties), a determined building device name, etc. Device database 518 and/or device location and spatial relation data 520 may be stored in a memory unit of configuration engine 502, in memory of building system server 516, and/or in any other local or remote memory device.

Referring also to FIG. 5B, database 530 is shown to include a table for storing device information for each building device. Database 530 may be device database 518, device location and spatial relation database 520, a combination of databases 518 and 520, a temporary table residing in memory of the configuration engine, a table in building system server 516, etc. It should be noted that any other data structure or data storage scheme may be used to represent the building device data. For example, XML may be used to describe the building device data or custom data structures may be defined in any number of programming languages (e.g., a C++ or Java object may be defined for each device). According to one exemplary embodiment a graphical object relating to the floor plan can be represented with the following data structure:

```
Class GraphicalObject {
    string: Name;
    string: device_type;
    number: device_id;
    point3D: world_coordinate;
    point3D: normalized_coordinate;
    polygon: bounding_contour;
}
```

Referring to the above data structure, “point3D” may be an object type for storing three dimensional data about a point in relation to a three dimensional coordinate grid. “polygon” may be a object type for a two dimensional bounding box data (e.g., data for bounding contour 408 shown in FIG. 4A). According to various exemplary embodiments, variables world_coordinate and/or normalized_coordinate are two dimensional coordinates.

Building device information stored in database 530 may include device properties, which may include information about the size, shape, and other physical properties of the building device, metadata of the building device (e.g., metadata that may be stored in layout database 514), etc. Device properties may also include information about the manufacturer, product name, part number, description, or other information regarding the device. Device properties may further include its IP address, MAC address 531, or other network property.

Database 530 is additionally shown to include geolocation properties or world coordinate data (e.g., latitude 532, longitude 533, altitude 534, scale, GPS data, GPS coordinates, etc.). Database 530 additionally includes normalized location data 535. Normalized location data 535 may be derived using geolocation properties and stored in database 530. Normalized location data 535 may be data that can be scaled for different resolutions while maintaining the data's shape and/or location relative to other objects, floor plan features, or other data. Database 530 additionally includes aspect ratio 536, which may represent a scale factor compared to the real-world size and shape of various objects. Aspect ratio 536 may be used by the system to relate a graphical indicator and/or graphical feature shown on floor plan 300 to real-world dimensions. For example, using aspect ratio 536, the system may know that a device indicator that is by default fifty pixels wide may represent a one foot wide device.

Database 530 may additionally include bounding contour data 537. Bounding contour data 537 may relate to the size, shape, or other physical or functional property of the building device. For example, for a motion sensor, bounding contour data 537 may include the range of the motion sensor and/or a bounding contour for the field of view of a video camera. Bounding contour data may be represented using coordinate points (e.g., polygon corner points) or otherwise.

Database 530 additionally includes spatial relation data 538. Spatial relation data 538 may be derived using geolocation properties 532-534, normalized location data 535, and bounding contour data 537 in conjunction with area properties (e.g., data from layout database 514) and/or properties of other building devices. World coordinate and bounding contour data may be represented by a point at which the indicator for the building device is located on the graphical representation of the floor plan. For example, a point on the edge of a bounding contour for a building device may be the normalized point location of the building device. According to an exemplary embodiment, different points of a bounding contour and/or the indicator may be selected (e.g., a left-most point, a highest or lowest point, etc.). World coordinate data may be generated with respect to the chosen point (e.g., latitude, longitude, scale, altitude, etc.) or pre-existing world coordinate data may be used to approximate a location for the indicator of the building device on the graphical representation of the floor plan. If the user moves the indicator, the normalized coordinate may be updated while the world coordinate is not. According to other exemplary embodiments, the movement of the indicator is used to provide approximate dead-reckoning relative to a world coordinate system.

Database 530 additionally includes device name data 539. The device name may be generated by configuration engine 502 and stored in database 530. Device name data 539 may also include unique machine addressable identifiers in addition to a generated name for a user. Database 530 may additionally include other building device information. For example, building device data stored may include time of building device operation (e.g., a building device may operate full-time or may operate only during business hours). By way of additional examples, motion detection threshold information for a sensor, a duration relating to an alarm mode, and other properties may be stored. According to one exemplary embodiment, any information entered using panel 404 of GUI 400 of FIG. 4A may be stored in database 530. Database 530 additionally includes device type 540 (e.g., a camera, type of sensor, etc.) and elevation 541 (e.g., the elevation of a device compared to ground level of the area the device is associated with).

Referring to FIG. 5C, a detailed block diagram of configuration engine 502 of FIG. 5A is shown, according to an exemplary embodiment. Processing circuit 552 may be a general purpose processor, an application specific processor (ASIC), a circuit containing one or more processing components, a group of distributed processing components, a group of distributed computers configured for processing, etc. Processing circuit 552 may be or include any number of components for conducting data and/or signal processing of the past, present, or future. Memory 554 (e.g., memory unit, memory device, storage device, etc.) may be one or more devices for storing data and/or computer code for completing and/or facilitating the various processes described in the present disclosure. Memory 554 may include volatile memory and/or non-volatile memory. Memory 554 may include database components, object code components, script components, and/or any other type of information structure for supporting the various activities described in the present disclosure. According to an exemplary embodiment, any distributed and/or local memory device of the past, present, or future may be utilized with the systems and methods of this disclosure. According to an exemplary embodiment, memory 554 is communicably connected to processing circuit 552 (e.g., via a circuit or any other wired, wireless, or network connection) and includes computer code for executing one or more processes described herein. A single memory unit may include a variety of individual memory devices, chips, disks, and/or other storage structures or systems. Modules, engines, or software components 556-574 may be computer code (e.g., object code, program code, compiled code, script code, executable code, or any combination thereof) for conducting each module's respective activities. Modules 556-574 may be stored in one or more local, distributed, and/or remote memory units configured to be in communication with processing circuit 552 or another suitable processing system.

Communications software 556 may be used as a communications link between a user of the building area and the device management system. Software may be coupled to communications interface 556 (e.g., communications interface 504) and may be configured to support communications activities of communications interface 556 (e.g., negotiating connections, communicating via standard or proprietary protocols, etc.).

GUI engine 558 may be used to create a GUI (e.g., GUI 400 of FIG. 4) for a user of the building area. GUI engine 558 may generate a graphic representation of all objects, building devices, sensors, building area, floor plan details, and/or components in a building area. GUI engine 558 may allow a user to edit, add, delete, and otherwise modify the various components of the building area. GUI engine 558 may include computer code for processing the normalized location data and/or bounding contour data to generate the graphical representations. GUI engine 558 may include a web server, a two dimensional graphics engine, a three dimensional graphics engine, plug-in code, or any other suitable logic or programming code for generating a GUI having the features and supporting the activities described in the present application.

Geo-locator 560 may be used to determine a physical location of a building device, area, or other component of the building area. Location normalizer 562 may convert geolocation information into a usable form for the device management system. According to an exemplary embodiment, the geolocation information may be normalized by converting the native data (e.g., GPS coordinates, CAD coordinates, etc.) into a two-dimensional format plus a value for elevation or floor level. For example, an x-y coordinate for a location may be formed using location normalizer 562.

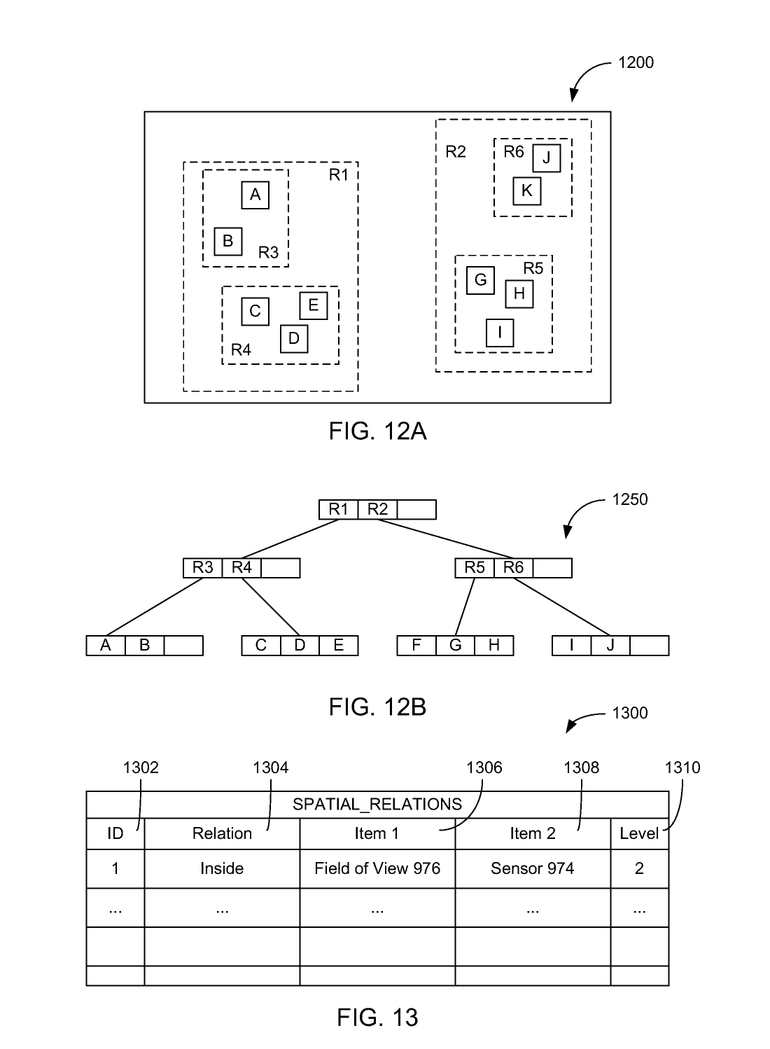

Indexing module 564 may sort data about various building devices and components of the building area. For example, indexing module 564 may provide a data structure or other organizational method for storing data about building devices of a specific building area. According to one exemplary embodiment, spatial data indexing may be performed. Indexing module 564 may generate index data for components based on the location of the component. For example, sensors of a particular area may be sorted via spatial data indexing based on the location of the sensors in the area. According to one exemplary embodiment, a tree structure may be used for spatial data indexing. For example, a quad-tree, MX-quad tree, KD-tree, R-tree, R*-tree, SS-tree, or TV-tree may be used. The location in the tree may indicate the relationship between building devices and/or floor plan aspects. Tree structures may be used to improve the search times for frequently occurring relationships and/or building devices. Indexing module 564 is described in greater detail in FIGS. 12A-B.

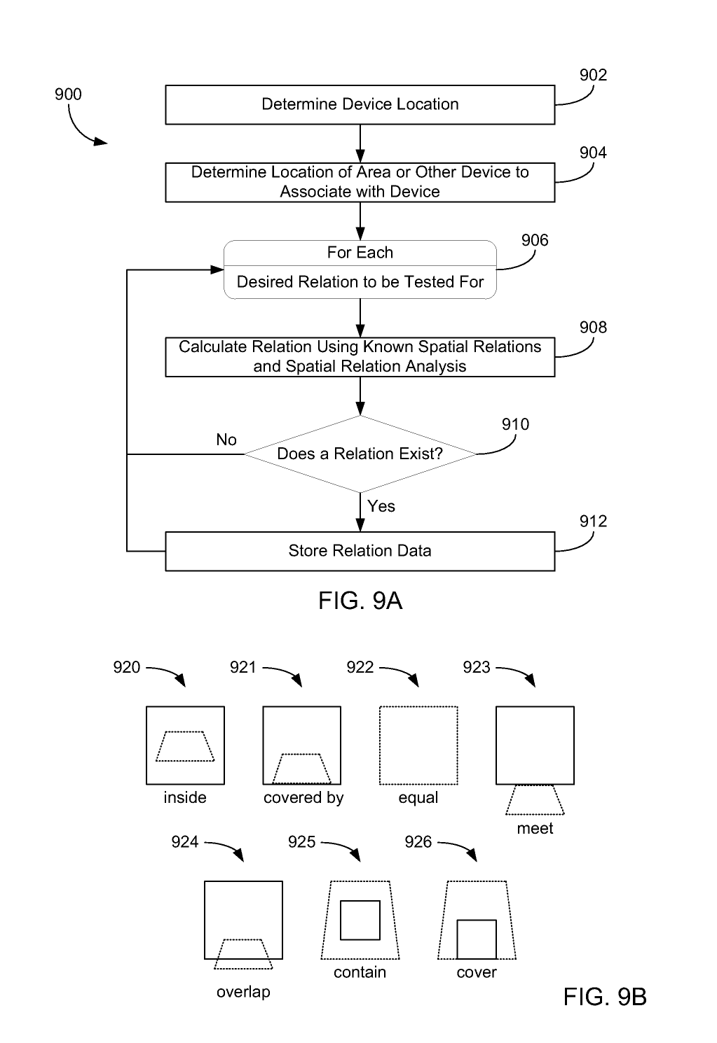

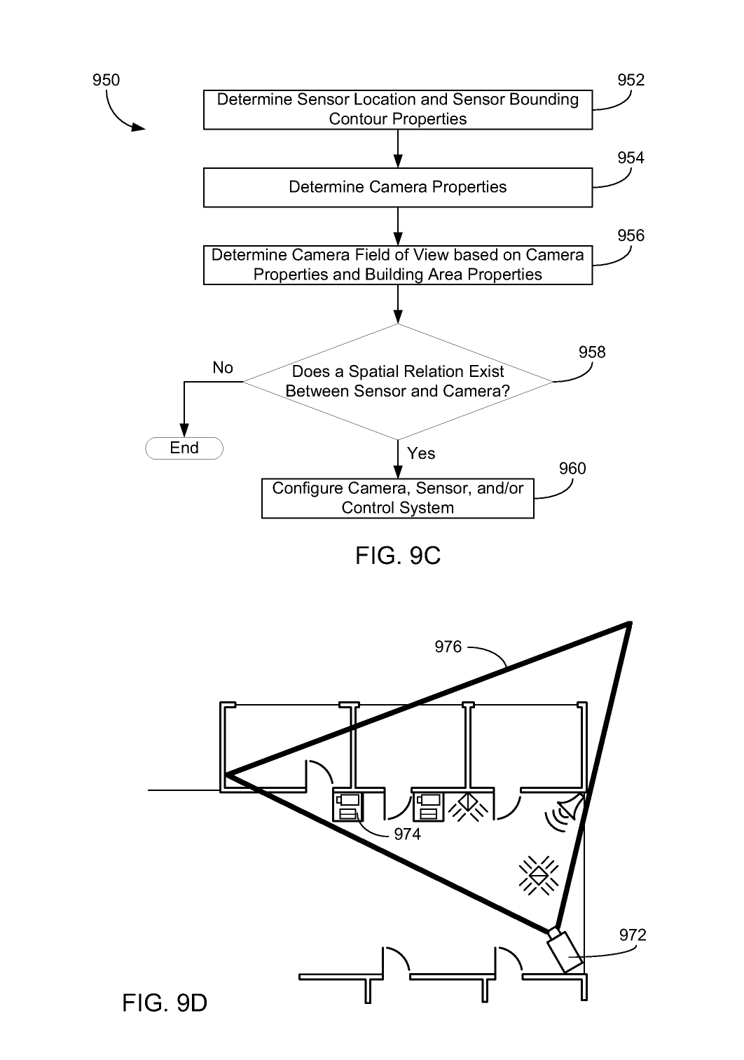

Association engine 566 may associate a building device, sensor, or other component with a specific building area (or another logical grouping), according to an exemplary embodiment. According to an exemplary embodiment, association engine 566 is configured to assign a building device, sensor, or other component to a specific area based on the properties of the component as entered or located on the GUI. For example, associations may be made by association engine 566 using the location of the component (e.g., geolocation or otherwise), the range of the component with relation to a building area location (e.g., the range of a motion sensor that may detect movement up to a certain radius away from the sensor), the location of a specific area (e.g., a room), etc. Association engine 566 is described in greater detail in FIG. 9A.

Naming module 568 may be configured to use logic to generate a name for each building device based on naming conventions for the building device. According to an exemplary embodiment, a single naming convention for each building area is used by naming module 568 so that every building device of the building area may abide by the convention in a normalized and differentiated fashion. According to one exemplary embodiment, naming module 568 may select a name for a building device based on the location of the building device and the type of the building device. For example, a card reader in a lab room may be assigned a name according to the following naming convention:

### “BuildingName.FloorName.RoomName.DeviceType.DeviceName”;

resulting in, for example:

### “Library.Floor2.ComputerLab1.CardReader.NorthEntranceReader”.

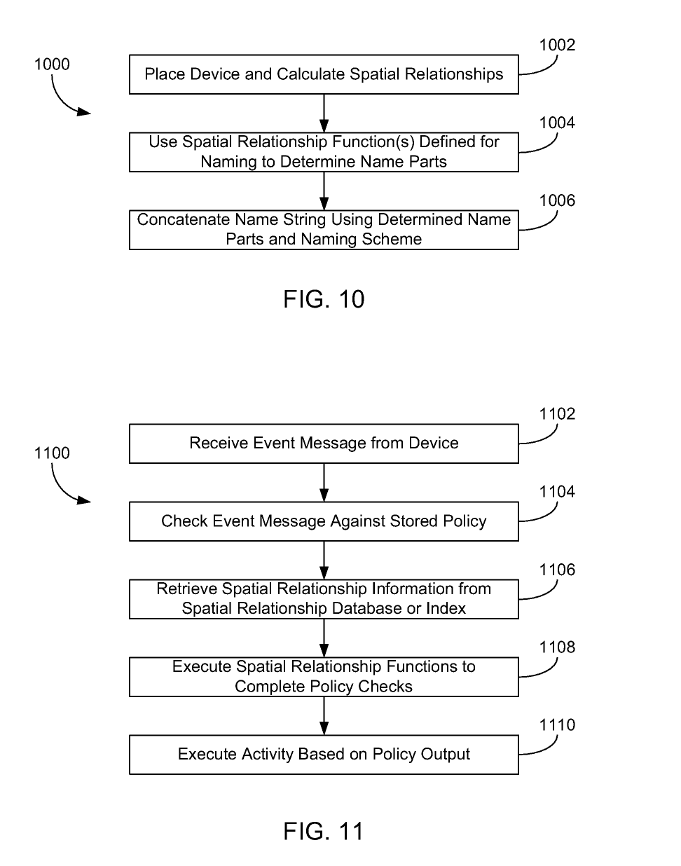

Naming module 568 is described in greater detail in FIG. 10.

Alarm/event engine 570 may be provided to generate alarms, alerts, and other messages relating to determined conditions. Alarm/event engine 570 may use a network of building devices, sensors, and other components and objects to determine if an alarm should be generated or if an event should be identified. Alarm/event engine 570 is described in greater detail in FIG. 11.

Building system client 572 may be coupled to building system server 516. Building system client 572 may be configured to facilitate communication between configuration engine 502 and building system server 516. For example, building system client 572 may be used to login to one or more building servers and to serve as a communication bridge between the building system and the configuration engine.

Connectivity module 574 may be used to determine and store physical connection information about various building devices of the building area. For example, connectivity module 574 may relate building device connections to locations (e.g., estimating locations when the building device is plugged in or otherwise connected). Connectivity module 574 may be used in conjunction with the other location modules (e.g., geolocator 560, location normalizer 562) to provide additional location information for the device management system. For example, if a sensor is wired to a controller for a certain room, connectivity module 574 be configured to relate the sensor to the controller and the room.

Referring to FIG. 6, a detailed flow diagram of a process 600 for adding a building device to a building area using a GUI is shown, according to an exemplary embodiment. Process 600 includes the step of retrieving data from the layout database (step 602). Step 602 may include the step of populating the layout database with plan data via a translator. A GUI is then generated (step 604) and an input from the GUI is received (step 606). Based on the received input (e.g., a selection of a particular building device type, location for the building device, or other building device properties) the system may determine a representative shape for the building device (step 608). The feature of determining a representative shape may be used, for example, when the shape to be placed on the floor plan shown in the GUI is to represent the shape and size (e.g., range) of the coverage for the building device. For example, while a sensor may be relatively small relative to the building space, the effective range of the sensor may be used to determine the size of the representative shape when placing the sensor on the GUI floor plan. Bounding contour data for the building device may be based on the determined representative shape, an actual perimeter of the building device, or otherwise (step 610). According to an exemplary embodiment, the bounding contour data describes the representative shape or the contour of the shape surrounding the device indicator on the GUI. Floor plan boundaries may be used to define the boundaries of various areas of the building area. According to an exemplary embodiment, the same bounding contour scheme used to describe a representative shape for building devices or device indicators is also used to describe building areas. Using the building area boundaries and the device's representative shape, the spatial relationships between the area and the building device may be analyzed (step 612). This analysis may include comparing bounding contour data for the building device to bounding contour data for the building area. Other spatial relation analysis techniques may be used according to various other exemplary embodiments (e.g., geolocation plus stored object dimensions may be used). Device properties to record relating to the building device may be assigned (step 614). The device properties and spatial relationships may be then be stored (step 616) in a memory unit, data structure, database, and/or index. For example, the properties and relationships may be stored in device location and spatial relation database 520.

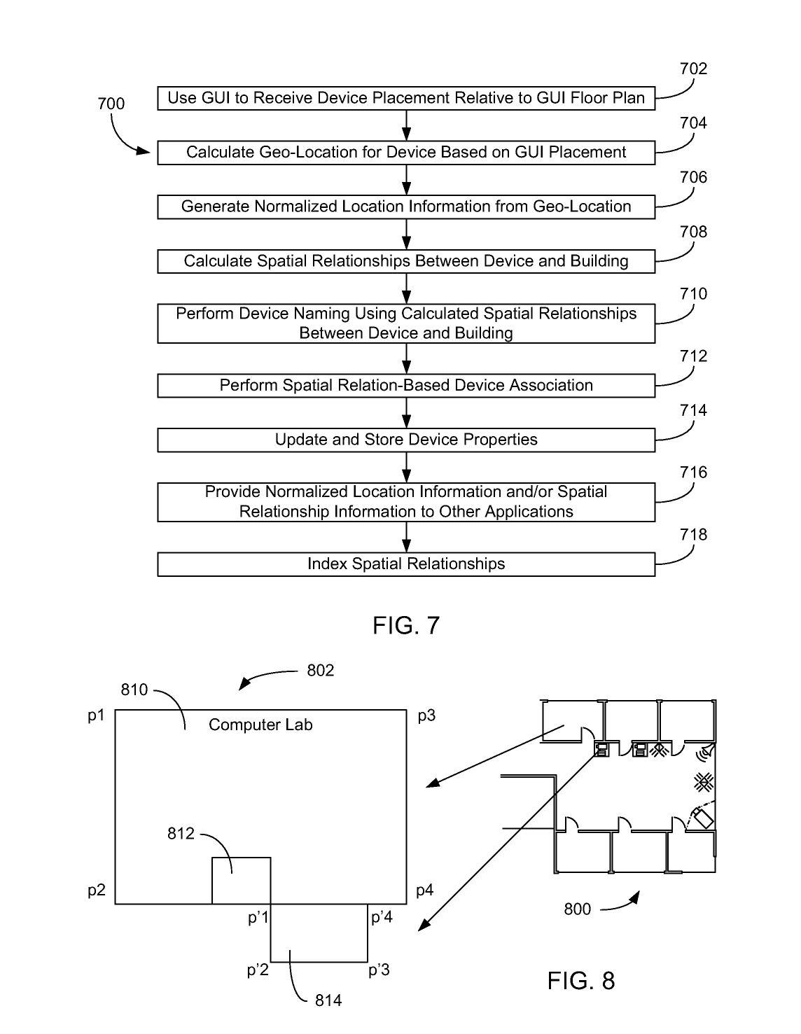

According to an exemplary embodiment, geolocation information may be used to inform the configuration of building devices using a device management system and/or method of the present application. Referring to FIG. 7, a flow diagram of a process 700 for configuring a building system using geolocation information is shown, according to an exemplary embodiment. Process 700 is shown to include receiving building device placement input from a user (step 702) (e.g., placing a device indicator). Based on the device indicator placement relative to the GUI floor plan, process 700 is shown to include calculating the geographical location (e.g., geolocation) for the building device (step 704). Calculating the geographical location may include adjusting an initial estimate of geographical location based on the distance between a known geographical point on the floor plan and the placed indicator for the building device. The known geographical point may be set based on a corner of the floor plan, a center point of the floor plan, a grid associated with the floor plan, or otherwise. According to an exemplary embodiment, the initial estimate may be obtained via a GPS receiver integrated with or coupled to the building device. In other words, the combination of a geographical location estimate and calculations relating to the placement of a device indicator on the representation of the floor plan may be used to provide “dead-reckoning” for the building device or to more accurately describe the geographical location of the building device. The geographical location of the building device may be stored for later use, printed as a part of a report, used in surveillance applications, and the like.

The geolocation and/or other location information (e.g., device indicator location on the GUI representation of the floor plan) may then be normalized into a form more suitable for spatial relationship analysis by the device management system (step 706). According to an exemplary embodiment, step 706 includes normalizing based on GUI relationships and does not consider, calculate, or normalize geolocation information. Normalizing the geolocation information may include converting GPS formatted coordinates into another scheme (e.g., number of arbitrary units from the center of the GUI representation of the floor plan, number of units from a corner of the floor plan, number of pixels from a reference pixel on the floor plan, etc.). Spatial relationship analysis may then be calculated using normalized data (step 708). Using the spatial relationships determined in step 708, the system may conduct a number of configuring activities. For example, the system may perform device naming using the spatial relationships (step 710), conduct spatial relation-based device association (step 712), store spatial relationships and/or other device properties (step 714), send normalized location information and/or spatial relationship information (index information) to other applications or systems (step 716), index spatial relationships (step 718), change values or settings based on the calculated relationships, establish building device policies or logic based on the determined spatial relationships, print a report of spatial relations, generate an XML document based on spatial relations, update database tables based on spatial relations, and the like.

FIG. 8 illustrates how spatial relationship data may be used to define and relate building spaces and associate building devices. FIG. 8 is a diagram of a floor plan representation 800 and a corresponding set of points and bounding contour data 802 generated and stored by the system. Area 810 is shown as a computer lab having a door 812 and a card reader 814. Building area 810 is defined by a bounding contour (e.g., a set of points and lines, a polygon outlining the area, etc.) having four endpoints p1-p4. Card reader 814 is defined by another bounding contour having endpoints p′1-p′4. The endpoints and other properties of the bounding contour may be used to relate computer lab 810 and card reader 814. For example, the system may be configured to relate a card reader 814 to a room if the bounding contour for the card reader is outside of the bounding contour for the room but shares a line with the bounding contour for the room and is nearby a door for the room. By way of further example, the system may relate room 810, door 812, and card reader 814. Card reader 814 may be named accordingly (e.g., “ComputerLab1.SouthDoor.CardReader1” may be the assigned name for card reader 814). Using these associations based on spatial relationships, the system may be configured to functionally configure building devices without manual human input. For example, card reader 814 may automatically be configured to send an unlock signal to associated door 812 over a network if cards having access to room 810 are read.

Referring now to FIG. 9A, a detailed flow diagram of a process 900 for associating a building device with another building device or an area is shown, according to an exemplary embodiment. The location of a building device may be determined (step 902). The location may be a relative location within the floor plan or be a geolocation. The location of other building devices and areas which can associate with the device may be determined (step 904). Location of building devices and areas may be determined using the previously described systems and/or processes (e.g., location determination via a GUI representation of a floor plan and device indicators). One or more spatial relations may be tested for each device/device and/or device/area pair that can be related (e.g., that are nearby or meet some other threshold requirement) (step 906).

Referring briefly to FIG. 9B, several examples of fundamental spatial relations 920-926 used by the system are shown. Spatial relations 920-926 illustrate sample relations between a first polygon and a second polygon. Spatial relation 920 illustrates a spatial relation where the first polygon is “inside” the second polygon (e.g., completely surrounded). Spatial relation 921 illustrates a spatial relation where the first polygon is covered by the second polygon (e.g., the first polygon is within the second polygon, but the two polygons share a border). Spatial relation 922 illustrates a spatial relation where the two polygons are equal. Spatial relation 923 illustrates a spatial relation where the two polygons “meet” (e.g., the two polygons share a border but do not share any area). Spatial relation 924 illustrates a spatial relation where two polygons overlap (e.g., each polygon has one area shared with the other polygon and a second area not shared with the other polygon). Spatial relation 925 illustrates a spatial relation where the first polygon contains the second polygon (e.g., the second polygon is completely within the first polygon). Spatial relation 926 illustrates a spatial relation where the first polygon covers the second polygon (e.g., the second polygon is covered by the first polygon). Fundamental spatial relations 920-926 may be used by other spatial relationship functions, queries, and/or as thresholds for determining whether or not to test for further relationships. For example, if a building device is not inside a room, the system may determine that there is no need to test for whether the building device is on a particular wall inside the room. Conversely, if the building device is inside the room, a distance between the center of the room and the building device may be calculated, a nearest wall determined, or any number of additional calculations may be made to describe in detail the relationship of the building device and the room. Referring back to FIG. 9A, when relations are calculated using spatial relation analysis (step 908) the system may determine whether relations exist (step 910) and store the spatial relation (step 912) in a database or elsewhere. As described, it is important to note that step 906 may not loop “for each” relation but the system may rather be configured to determine whether a relationship is likely to exist or whether a fundamental relationship exists prior to testing for another relationships.

### Exemplary Spatial Relationship Functions for Use with the Device Management System

According to one exemplary embodiment, a geometric algebra based approach may be used to conduct the spatial relationship analysis (e.g., analysis regarding the topological relation between two polygons, points, or lines). In other words, a building device or other object of a building area may be represented as a polygon, point, or line, and topological relations between the building devices, building area, and/or other objects may be found using the geometric algebra approach. According to an exemplary embodiment, each building device is be associated with a polygon, point, or line that is representative of an area for which the building device is valid (e.g., a door lock may be associated with a small rectangle, a card reader may be associated with a small area in which a card may be readable by the card reader, etc.). The determination of these polygons, points, and/or lines may be conducted as a part of the normalizing steps mentioned in the present application.

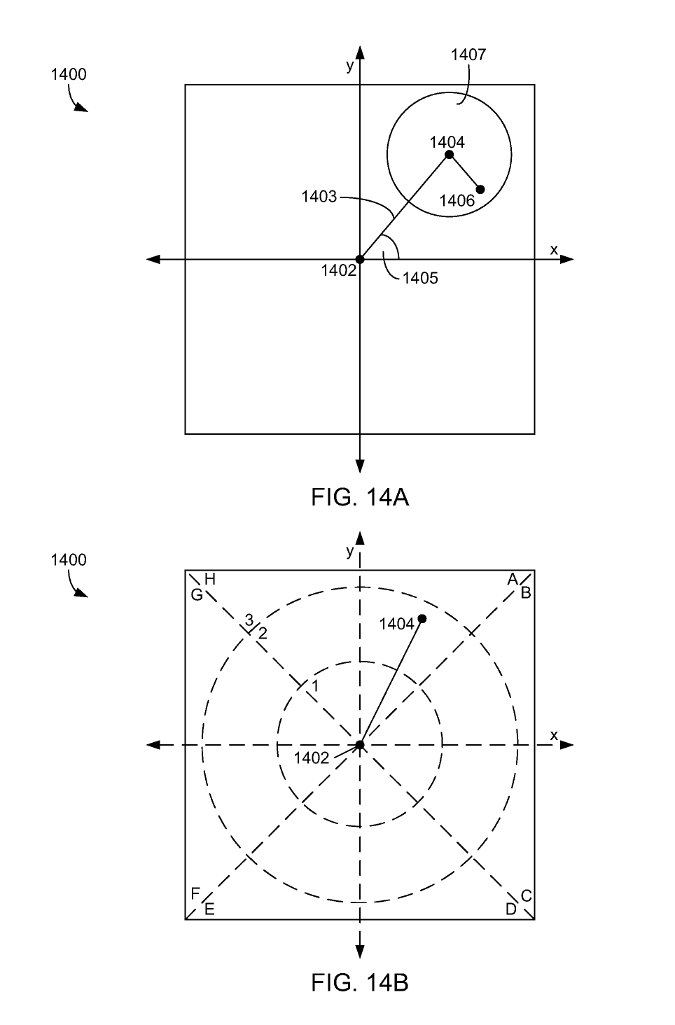

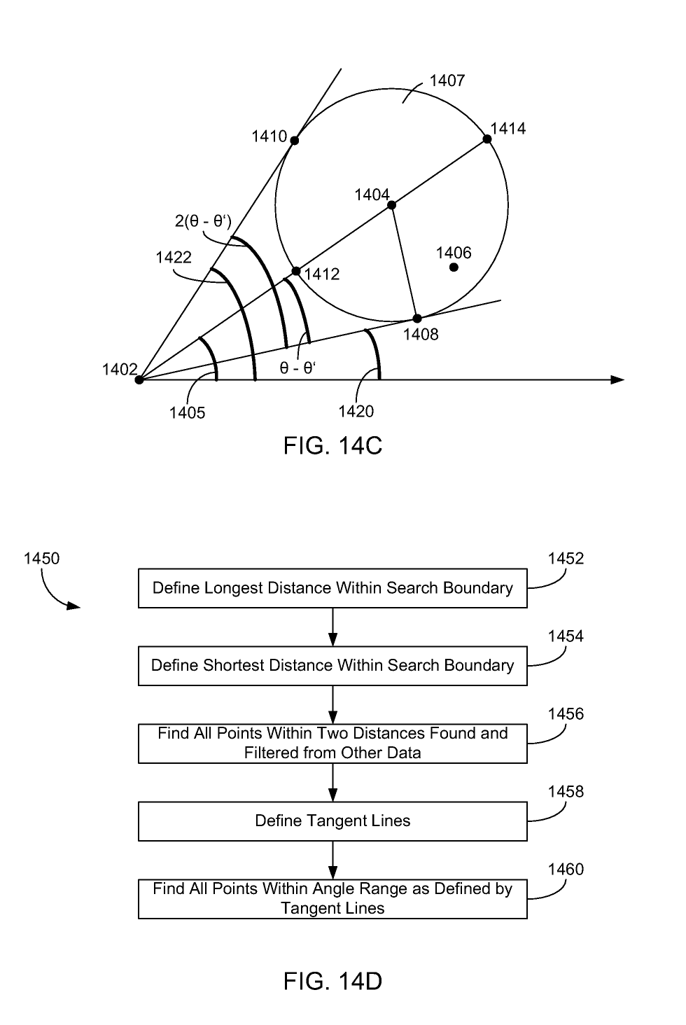

Spatial relation analysis may utilize several spatial relation functions for comparing two points. According to an exemplary embodiment, a point P_{A}=(xₐ, yₐ, i) describes a discrete x-axis and y-axis location for an identified frame i (e.g., video frame, GUI frame, etc.). From the defined spatial relation functions shown in the following table, various qualitative and/or quantitative relationships may be derived. The derived relationships can be directional relations which include north, south, east, west, boolean relations, absolute relations, distance relations, vector-based relations, or otherwise. For example, the set of spatial relation functions is shown to include an “on” function configured to determine if two points are equal, a “disjoint” function configured to determine if two points are not equal, a “direction” function configured to determine a direction that one point is from another point, and a “distance” operation configured to determine the distance between two points (or objects). According to an exemplary embodiment, the distance function may be used to assist with storing distance relationships in a standard relational database (see FIGS. 14A-D). An input/output signature is shown for each exemplary function as well as a definition of the logic for each function:

| Function | Signature | Meaning |
|---|---|---|
| on | point × point → boolean | $\{ \begin{matrix}for given two points ; {p}_{a} = ( {x}_{a} , {y}_{a} , i ) and {p}_{b} = ( {x}_{b} , {y}_{a} , j ) \\ if ( {x}_{a} = {x}_{b} ⋀ {y}_{a} = {y}_{b} ⋀ i = j ) \to True \\ otherwise False\end{matrix}$ |
| disjoint | point × point → boolean | $\{ \begin{matrix}for given two points ; {p}_{a} = ( {x}_{a} , {y}_{a} , i ) and {p}_{b} = ( {x}_{b} , {y}_{a} , j ) \\ if ( {x}_{a} \neq {x}_{b} ⋀ {y}_{a} \neq {y}_{b} ⋀ i \neq j ) \to True \\ otherwise False\end{matrix}$ |
| direction | point × point → vector | 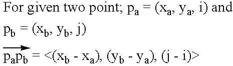 |
| distance | point × point → integer | dₚ^{Spatio-temporal} (P, Q) = \sqrt{(x_{b} − xₐ)² + (y_{b} − yₐ)² + (j − i)²} |

A line L is defined as a set of points that includes (or joins) two distinct points (e.g., endpoints) and all points of the line between those two points (e.g., L={pᵢ=(xᵢ,yᵢ,l), . . . , pⱼ=(xⱼ,yⱼ,m): pᵢ≠pⱼ,l,m,x,yεINTEGER}). Several possible spatial relations may be formed between a line and a point. Exemplary functions shown in the following table illustrate an “on” function to determine if a point is on a line, a “disjoint” function to determine if a point is not on a line, and a “meet” function to determine is a point is an endpoint of the line. An input/output signature is shown for each function as well as a definition of the logic for each function:

| Function | Signature | Definition |
|---|---|---|
| on | point × line → | If a point pₐ is an element of L and the |
| | boolean | pint doesn't meet with L. |
| | | $\{ \begin{matrix}if ( ( {p}_{a} ∈ L ) ⋀ {p}_{a} \neq {p}_{i} ⋀ {p}_{a} \neq {p}_{j} ) \to True \\ otherwise False\end{matrix}$ |
| disjoint | point × line → | A point doesn't meet with L and is not |
| | boolean | on L |
| | | $\{ \begin{matrix}if ( {p}_{a} ∉ L ) \to True \\ otherwise False\end{matrix}$ |
| meet | point × line → boolean | $\{ \begin{matrix}if ( {p}_{i} = {p}_{a} ⋁ {p}_{j} = {p}_{a} ) \to True \\ otherwise False\end{matrix}$ |

Several possible spatial relations may be formed between two lines L1 and L2. For example, a “get angle” function may be configured to determine an angle between two lines, an “equal” function may be configured to determine if two lines are identical, a “meet” function to determine if two lines meet, an “overlap” function to determine if one line overlaps the other, a “disjoint” function and “intersect” function to determine if two lines do not share a point or do share a point, respectively, and a “length” function to determine the length of one line.

The following table lists several exemplary spatial relationship functions that may be used with the present application, an input/output signature for each function, and a definition of the logic for each function:

| Function | Sig. | Definition |
|---|---|---|
| get angle | line × line → integer | Range [0, . . . 360], inner angle between two lines |
| equal | line × line → boolean | $\{ \begin{matrix}if ( ( ( L 1 ⋃ L 2 ) = L 1 ) ⋀ ( ( L 1 ⋃ L 2 ) = L 2 ) ) \to True \\ otherwise False\end{matrix}$ |
| meet | line × line → boolean | $\{ if \begin{matrix}\{ \begin{matrix}\begin{matrix}\begin{matrix}( ( ( ( {p}_{i} on {p}_{s} ) ⋀ {p}_{i} equal {p}_{r} ) ⋁ ( {p}_{i} equal {p}_{s} ⋀ {p}_{i} equal {p}_{r} ) ⋁ \\ ( {p}_{j} equal {p}_{s} ⋀ {p}_{j} equal {p}_{r} ) ⋁ ( {p}_{j} equal {p}_{s} ⋀ {p}_{j} equal {p}_{r} ) ) ⋀\end{matrix} \\ ( L {1}^{sub} ⋂ L {2}^{sub} = φ ) ) \to True\end{matrix} \\ where , L {1}^{sub} = L 1 - \{ {p}_{i} , {p}_{j} \} and L {2}^{sub} = L 2 - \{ {p}_{s} , {p}_{r} \}\end{matrix} \\ otherwise False\end{matrix}$ |
| overlap | line × line → boolean | $\{ \begin{matrix}if ( ( L 1 ⋐ L 2 ) ⋀ ( L 1 meet L 2 ) = False \\ ⋀ ( L 1 equal L 2 ) = False ) \to True \\ otherwise False\end{matrix}$ |
| disjoint | line × line → boolean | $\{ \begin{matrix}if ( L 1 ⋂ L 2 ) = φ \to True \\ otherwise False\end{matrix}$ |
| intersect | line × line → boolean | $\{ \begin{matrix}if ( ( L 1 ⋂ L 2 ) = \{ {p}_{k} \} ) ⋀ ( L 1 meet L 2 ) = False ) \to True \\ otherwise False\end{matrix}$ |
| length | line → integer | length(pᵢ, pⱼ) = \sqrt{(xᵢ − xⱼ)² + (yᵢ − yⱼ)² + (l − m)²} |

A bounding counter BC (e.g., a polygon) may be defined by a set of points and a set of non-intersecting line segments: BCᵢ=<P,L,i>. Bounding contours may be made by coplanar segments such that each segment intersects exactly two other segments (one at each endpoint) and that no two segments with a common endpoint are collinear.

Various spatial relations may be formed between a bounding contour and another bounding contour, point, or line. For example, a “point on” function determines if a point is on the border of the bounding contour, an “area inside” function determines if one bounding contour is inside the other, a “line inside” function to determine if a line within one bounding contour is within another bounding contour, a “point inside” function to determine if a point within one bounding contour is within another bounding contour, a “area disjoint” function to determine if two bounding contours are disjoint, a “line disjoint” function to determine if two bounding contours do not share a line, and a “point disjoint” function to determine if two bounding contours do not share a point. Additionally, an “area” function may be included to determine the area of a bounding contour and a “center” function may determine the geometric center of the bounding contour. A “nearby” function may determine if two bounding contours are nearby (e.g., by taking the center points of the two bounding contours and checking if the distance between the two points is less than a preset threshold).

The following table lists exemplary functions, their input/output signatures, and a definition for each function:

| Function | Sig. | Definition |
|---|---|---|
| point on | BC × | p_{y} point_on BCᵢ^{f} |
| | point → | For given bounding contour BCᵢ^{f} =< pᵢ^{f}, Lᵢ^{f}, f >, |
| | boolean | and a point; pᵥ = (xᵥ, yᵥ, f) on the f^{th} frame. |
| | | lᵢ^{f} (s) denotes the s^{th} line segment on |
| | | Lᵢ^{f} = {lᵢ^{f} (1), lᵢ^{f} (2), . . . , lᵢ^{f} (u)} |
| | | if (∃x((p_{y} on lᵢ^{f} (x))) ≠ φ) → True |
| | | otherwise False |
| area | BC × BC → | Given two bounding contours; |
| inside | boolean | BCᵢ =< Pᵢ, Lᵢ, 1 > and BCⱼ =< pⱼ, Lⱼ, m > |
| | | where, Pᵢ = {p₁ⁱ, . . . , pᵤⁱ}, Pⱼ = |
| | | {p₁ⁱ, . . . , pᵥⁱ}, |
| | | pᵢ(w):w^{th} bounding contour control points in p₁ |
| | | Lᵢ = { p̅ₗ̅ⁱ̅p̅₂̅ⁱ̅, p̅₂̅ⁱ̅ p̅₃̅ⁱ̅, . . . , p̅ᵤ̅ⁱ̅ p̅₁̅ⁱ̅}, |
| | | and Lⱼ = { p̅₁̅^̅{̅j̅}̅ p̅₂̅^̅{̅j̅}̅,̅ p̅₂̅^̅{̅j̅}̅ p̅₃̅^̅{̅j̅}̅, . . . , p̅ᵥ̅^̅{̅j̅}̅ p̅₁̅^̅{̅j̅}̅} |
| | | lᵢ(s):s^{th} line segment on Lᵢ = |
| | | {1ᵢ(1), 1ᵢ(2), . . . , 1ᵢ(u)} |
| | | Let a set of all points inside BCᵢ (not on Lᵢ) be |
| | | Pᵢ^{inside} and a set of all points on Lᵢ be Pᵢ^{on}. |
| | | BCᵢ area_disjoint BCⱼ |
| | | {if (Pᵢ^{inside} ⊂ Pⱼ^{inside}) → True |
| | | otherwise False |
| line | BC × BC → | BCᵢ line_inside BCⱼ |
| inside | boolean | If (((BCᵢ area_inside BCⱼ) = True) [symbol] |
| | | (Lᵢ overlap Lⱼ = False) [symbol] |
| | | (Lᵢ meet Lⱼ = False)) → True |
| | | otherwise False |
| point | BC × BC → | BCᵢ point_inside BCⱼ |
| inside | boolean | $\{ \begin{matrix}if ( ( ( {BC}_{i} line\_inside {BC}_{j} ) = True ) ⋀ \\ ( {P}_{i}^{on} ⋂ {P}_{j}^{on} \neq φ ) ) \to True \\ otherwise False\end{matrix}$ |
| area | BC × BC → | Given two bounding contours; |
| disjoint | boolean | BCᵢ =< Pᵢ, Lᵢ, 1 > and BCⱼ =< Pⱼ, Lⱼ, m > |
| | | Let a set of all points inside BCᵢ (not on Lᵢ) be |
| | | Pᵢ^{inside} and a set of all points on Lᵢ be Pᵢ^{on}. |
| | | BCᵢ area_disjoint BCⱼ |
| | | if (Pᵢ^{inside} ∩ Pⱼ = φ [symbol] Pⱼ^{inside} ∩ Pᵢ = φ) → True |
| | | otherwise False |
| line | BC × BC → | BCᵢ line_disjoint BCⱼ |
| disjoint | boolean | If (((BCᵢ area_disjoint BCⱼ) = True) [symbol] |
| | | (Lᵢ overlap Lⱼ = False) ! (Lᵢ meet Lⱼ = False)) → |
| | | True |
| | | otherwise False |
| point | BC × BC → | BCᵢ point_disjoint BCⱼ |
| disjoint | boolean | $\{ \begin{matrix}if ( ( ( {BC}_{i} line\_inside {BC}_{j} ) = True ) ⋀ \\ ( {P}_{i}^{on} ⋂ {P}_{j}^{on} \neq φ ) ) \to True \\ otherwise False\end{matrix}$ |
| area | BC → | Area of BC; A, is defined given points |
| | integer | P = {i = 1, . . . , v, with x₀ = xᵥ and y₀ = |
| | | yᵥ:(xᵢ, yᵢ)}. |
| | | $A = \frac{1}{2} {\sum }_{i = 1}^{i = v - 1} {a}_{i} , where {a}_{i} = {x}_{i} {y}_{i + 1} - {x}_{i + 1} {y}_{i}$ |
| center | BC → point | Center_of_region = ( x̅,̅ y̅), |
| | | $where \overline{x} = \frac{1}{v} {\sum }_{( x , y )} {\sum }_{∈ N} x , \overline{y} = \frac{1}{v} {\sum }_{( x , y )} {\sum }_{∈ N} y$ |
| nearby | BC × BC → | If (Distance( Center(BC1 ), |
| | boolean | Center(BC2 )) < threshold ) → true; |
| | | Otherwise false; |

Using these functions, various other topological relations may be derived. For example, the “overlap” and “meet” functions as described in FIG. 9B are shown as functions in the following table:

| Function | Signature | Definition |
|---|---|---|
| BCᵢ overlap BCⱼ | BC × BC→ | Given two boundingcontours; |
| | boolean | BCᵢ =< Pᵢ, Lᵢ, 1 > and BCⱼ =< Pⱼ, Lⱼ, m > |
| | | Let a set of all points inside in BCᵢ (not on Lᵢ) be |
| | | _{Pi}^{inside} and a set of all points on Lᵢ be _{Pi}^{on}. |
| | | if ((_{Pi}^{on} ∩ _{Pj}^{inside} ≠ φ) [symbol] (_{Pj}^{on} ∩ _{Pi}^{inside} ≠ φ)) → True |
| | | otherwiseFalse |
| BCᵢ meet BCⱼ | BC × BC→ | If ((Pᵢ^{on} ∩ Pⱼ^{on}) ≠ φ [symbol] |
| | boolean | (BCᵢ area_disjoint BCⱼ) [symbol] |
| | | (BCᵢ line_disjoint BCⱼ)) → True |
| | | otherwise False |

Using the functions described in the tables, various types of spatial relations may be tested for and used in the device management system. Any two building devices, areas, or other components of the building area may be related together (or tested for a relation) using the spatial relation functions as shown in the tables.

It should be noted that each of the above-defined functions may be implemented in hardware, software, or a combination of hardware and software. Some of the functions may be pre-calculated and stored in a database or another data structure for use by other functions. According to an alternative embodiment, all of the functions are calculated on an ad-hoc or on-demand basis.

### Configuring Camera Logic Using Spatial Relations

An exemplary application of the presently described system and/or method is illustrated in FIG. 9C and FIG. 9D, according to an exemplary embodiment. Referring to FIG. 9C, a flow diagram of a process 950 for configuring a camera (e.g., camera 972 shown in FIG. 9D) and/or logic for the camera based on a relationship with another building device is shown, according to an exemplary embodiment. Sensor location and bounding contour properties may be determined (step 952). Camera properties may also be determined (step 954). Camera properties may include the location of the camera or functionality of the camera (e.g., if the camera rotates, if the camera tilt angle is adjustable, etc.). According to an exemplary embodiment, a field of view for the camera is determined based on entered, sensed, or known camera properties and building area properties (step 956). Referring also to FIG. 9D, a camera field of view 976 for camera 972 is shown. Field of view 976 may be determined using knowledge about potential camera rotation and movement, range or depth of the camera, and other camera properties. Field of view 976 may be defined by a bounding contour forming a triangle and shown over the GUI floor plan, according to one exemplary embodiment.

Referring back to FIG. 9C, a determination as to whether a spatial relation exists between the sensor and camera (step 958). For example, also referring to FIG. 9D, a spatial relation between sensor 974 and the field of view 976 for camera 972 may be tested. Because sensor 974 is inside field of view 976 of camera 972, spatial relation function “line_inside” from the above table may return “true” when passed the bounding contour for sensor 974 and the bounding contour for field of view 976. When function “line_inside” returns true, a logic module of the device management system may then be configured to configure the camera, the sensor, and/or the control system for the camera and/or the sensor (step 960). Configuring may be updating a database table, storing a relationship, indexing a relation, or otherwise. Configuring may also include programming the control system for the camera to react to events generated by the sensor.

According to an exemplary embodiment, process 950 may be altered to include spatial relation analysis for multiple cameras instead of a single camera, allowing an optimal camera for viewing the area around the sensor to be selected. For example, all cameras that have a spatial relation indicating that an area associated with the sensor is within the field of view of the camera may be compared. A weighted calculation (or some other logic) within the configuration engine may determine which camera can most clearly capture the largest sensor area. For example, the camera with a narrow field of view relative to the sensor (e.g., the field of view that may show the areas of interest in the highest detail) may be chosen for best viewing of the sensor.

According to an exemplary embodiment, field of view 976 may be adapted to be used with other systems and methods of the device management system. For example, given a camera location and its field of view, various spatial relation queries may be performed. For example, a function to find all sensors or types of sensors (e.g., security sensors) within a specified radius (e.g., 50 feet, 200 feet, etc.) or within a specified field of view (e.g., field of view 976) may be used.

### Device Naming According to Spatial Relationships

Referring to FIG. 10, a flow diagram of a process 1000 of naming a building device is shown, according to an exemplary embodiment. Process 1000 is shown to include the step of placing a building device on the GUI and calculating spatial relationships based on the placement of the building device relative to other building devices and/or the graphical representation of the floor plan (step 1002). Multiple spatial relationship functions may be used to generate a name for a building device. According to an exemplary embodiment, device names are broken into name parts. For example, a device name may include a parent part and a unique device descriptor part. The parent part may be a string of descriptive text used to describe another building device (e.g., “Door”) or a parent area (e.g., “ComputerLab1”). According to an exemplary embodiment, one or more spatial relationship functions are used to determine which parent part to associate with any given unique device descriptor part (step 1004). It is important to note that while one spatial relationship may be used and stored as the formal name for a building device, multiple device names may exist based on spatial relationships. In other words, multiple spatial relationship strings may point to the same building device. This feature may provide flexible and intuitive ways to access each building device. For example, a building device's formal name may be tied to location (e.g., “Library.ComputerLab1.CardReader1”) but may also be accessed via another name (e.g., “Halll.Camera.Target.CardReader1”). As the above examples illustrate, process 1000 may further include concatenating name strings using the determined name parts and/or a naming scheme (step 1006). Predefined or user-defined name schemes may be stored in the system, edited, deleted, added, or otherwise changed by a user of the system.

A naming scheme may be used for searching and matching purposes, according to an exemplary embodiment. For example, each building device inside a building area (e.g., determined using the “area_inside” function described above) may be named to include the name of the building area. A camera inside a building space named “Computer Lab 1” may include the substring “ComputerLab1” in the camera's device name. Using self-identifiable or self-describing names may facilitate improved user understanding of the system and/or the relationships between devices and spaces. Self-describing names may also facilitate improved search speed. For example, multiple databases may not need to be queried to search for all building devices inside “computer lab 1”. Additionally, particular device types for the computer lab may be identified based on simple string searching. For example, searching for all card readers within computer lab 1 may be accomplished by searching for device names containing the substring “ComputerLab1.CardReader”. According to one exemplary embodiment, a prefix tree may be used for this purpose. A structured query language (SQL) command (e.g., a “like” command, a “not like” command, etc.) or other function may be used in the searching process. For example, the following SQL statement may be used to find all devices in a table names “RelationTable” whose device name includes the string “ComputerLab”: Select Device from RelationTable where DeviceName like ‘% ComputerLab %’

Using the naming convention described above or otherwise, all devices in the computer lab may be found using the SQL statement.

Also referring to FIG. 8, spatial relation functions may be used to determine if a building device and area or another building device are related. For example, if area 814 represents a card reader, a function may be used to determine if card reader 814 and computer lab 810 are related. If so, a naming convention may be used to assign a name to card reader 814. In pseudo code, for example:

if (ROOM(ComputerLab) and (ComputerLab meet CardReader)) then
CardReader.Name=ComputerLab.Name+CardReader.Device.Name

In the above pseudo code, if the computer lab is determined to be a room, and the “meet” function for the computer lab and card reader returns a value of true, then the name of the card reader is set to a combination of the computer lab name and the card reader name.

### Alarm Verification & Event Checking

Building devices are often configured to send alarms or event signals to a supervisory controller. For example, access controls are typically configured to send an alarm to an upstream controller in a security system. The controller is typically configured to forward the alarm message (e.g., to a law enforcement agency) or to conduct a disruptive activity based on the alarm (e.g., activate a siren and flashing lights). Applicant has found that improved knowledge of spatial relationships between devices can be used to verify alarms and to check event accuracy.

Referring now to FIG. 11, a flow diagram of a process 1100 for processing an alarm or event relating to a building device is shown, according to an exemplary embodiment. Process 1100 is shown to include the step of receiving an event message from the building device (step 1102). Each event message may be associated with one or more policies for other building devices or building system activities. For example, an invalid card swipe message sent from a card reader may be associated with a camera policy and an alarm policy. Once a message is received from the building device, the message may be checked against one or more policies (step 1104). Checking the one or more policies may include using retrieving spatial relationship information from one or more spatial relationship database or index (step 1106). If the spatial relationship required for completion of the policy check is not available, checking the one or more policies may further include executing spatial relationship functions (step 1108).

According to an exemplary embodiment, each policy is a set of computer code (e.g., a script, a function, an executable, object code, etc.) that is configured to accept one or more event messages as inputs and to provide one or more result messages (or signals) as outputs. Output from each policy may be sent to another building device, a supervisory node, another set of computer code, and/or any other system or function configured to receive, parse, and handle the output. According to an exemplary embodiment, a software module of the system is configured to execute an activity based on received policy output (step 1110). The activity could be to send an e-mail with an alert, to generate an audible alarm via an alarm device, to send a control signal to another building device, or to conduct any other activity.

According to an exemplary embodiment, a configuration engine or other hardware and/or software module of the system (e.g., a policy builder) may be configured to allow users to build custom policies using any number of standard or custom spatial relationship functions. The policy builder may receive text input, natural language input, provide a GUI for building a graphical policy, or the like.

An exemplary policy that the system may use would aim a nearby camera at a card reader that has generated an invalid card swipe. Another policy may send a feed from an aimed camera to an active video monitor. Yet other policies or logic modules utilizing policies may be configured to check for a plurality of conditions to exist. For example, if motion is detected in a closed room but doors for the room have not opened and cameras in the room have detected no human objects, the policy or logic module may be configured to determine that the motion sensor is faulty or that the room should be inspected but than a high-level alarm should not yet be generated.

According to yet other exemplary embodiments, a logic module may be configured to escalate an alarm or to ensure that an alarm is elevated in importance if multiple policies indicate that a room has been breached. For example, the logic module may be configured to determine with a relatively high degree of confidence that an “intruder” alarm should be generated and transmitted to law enforcement officials if a door sensor sends an invalid entry message, a related camera detects an unrecognized face for a person, and a related motion detector is triggered after business hours.

### Indexing and Storing Building Devices Based on Spatial Relationships

According to one exemplary embodiment, indexing may be used to store and access spatial relationship information. Referring now to FIG. 12A, a schematic diagram of a floor plan 1200 is shown, according to an exemplary embodiment. Floor plan 1200 is shown as divided into various areas. For example, floor plan 1200 is divided into two areas, area R1 and area R2, that may correspond to a first room and a second room. Each area is shown to include sub-areas. For example, area R1 is shown to include sub-areas R3 and R4, and area R2 is shown to include sub-areas R5 and R6. Each building device A-K located within floor plan 1200 is shown located within one or more areas. For example, devices A and B are shown as located within areas R1 and R3. It is important to note that the system may be configured to create area boundaries that do not correspond to actual physical boundaries or rooms (e.g., R1 could refer to a west side of a warehouse and R2 could refer to an east side of a warehouse).

Referring now to FIG. 12B, an R-tree 1250 is illustrated that holds location data for various areas and building devices of floor plan 1200. Tree-based indexing structures other than R-trees may also be used for indexing (e.g., quad-trees, MX-quad trees, KD-trees, R*-trees, SS-trees, TV-trees, etc.) devices and areas.

Tree 1250 may be built by first defining the “largest” or “top level” areas. For example, also referring to FIG. 12A, areas R1 and R2 may be designated as a top level (e.g., based on size, importance, user input, computer logic, etc.). A new area or sub-area may then be inserted into tree 1250 using various tree insertion algorithms (e.g., a tree insertion algorithm corresponding to an R-tree type). According to one exemplary embodiment, the area portions of tree 1250 may be pre-defined by a user (e.g., all relationships between areas and sub-areas may be defined by the user). According to other exemplary embodiments, a new sub-area may be added to tree 1250 individually using an insertion algorithm. All but the bottom level of the tree is shown to represent a sub-area. For example, in tree 1250, R3 and R4 are defined as the sub-areas of area R1 by their location in the tree as children of R1.

According to an exemplary embodiment, a new building device may be inserted into R-tree 1250 by indexing module 564 shown in FIG. 5 when the device is placed in floor plan 1200 (e.g., via GUI 400 shown in FIG. 4). The insertion of the new building device may include associating the building device using one or more spatial relationship functions described above or otherwise. According to one exemplary embodiment, when a new building device is added, the dimensions of various areas and sub-areas may be calculated and changed to allow the system to properly assign the new building device to an area and/or sub-area. For example, if a building device is placed that overlaps between areas R3 and R4, the boundaries of either area R3 or R4 may be changed. R-tree insertion and deletion algorithms may be used when a device is added, deleted, or moved within tree 1250. Tree 1250 may be used in searching for building devices. For example, a search for all devices within sub-area R3 may return A and B as a result by searching for R3's children nodes.

Other storage techniques for storing and accessing spatial relationships may be used in addition to or instead of tree-based indexing. Devices, areas and relationships may be stored using relational database systems. Referring to FIG. 13, a table 1300 for storing spatial relationship data is shown. The table may be created using a SQL statement such as:

CREATE TABLE SPATIAL_RELATIONS (id INTEGER NOT NULL), relation INTEGER, item1 INTEGER, item2 INTEGER, level INTEGER).

An ID 1302 is provided for each discovered spatial relationship and may be used to uniquely identify each spatial relationship. A relation field 1304 indicates the type of spatial relationship shared by items 1306 and 1308. For example, the relation “inside” is shown in field 1304. It is important to note that each field might relate to yet another table (e.g., a table relating relation integers with relation descriptors, a device table having a detailed device record related to item identifiers, etc.). Also referring to FIG. 9D, field of view 976 and sensor 974 have a spatial relationship (e.g., sensor 974 may be determined to be “inside” of field of view 976 based on spatial relation analysis). Therefore, field of view 976 and sensor 974 are stored in the two item fields 1306, 1308 of table 1300 along with the “inside” relation 1304. According to various exemplary embodiments, items may be sensors, other devices, cameras, areas, or otherwise. A level field 1310 may be provided in table 1300. Level field 1310 may be used to indicate a floor level, an elevation, or other location information regarding the stored spatial relationship.

According to another exemplary embodiment, spatial relationships may be stored in different or multiple tables based on the type of relationships, the devices involved, or other criteria. For example, all spatial relationships that are defined by the “inside” function may be stored in a single table. Using the spatial relationship functions and tabular indexing methods, the system and/or a user interacting with the system can query the system using well known methods. For example, a SQL command may be used to search for spatial relationships and to create a new table or report.

### Distance Storage Using Spatial Relation Analysis

Distance may be used to help define one or more spatial relationships between devices and/or building structures. Distance may also be used to support the indexing and/or storage of relationships.

Referring to FIG. 14A, a graph representing a building area 1400 is shown, according to an exemplary embodiment. Various objects within area 1400 may be represented by points in 2D space (for example, the graph of area 1400 is shown in an XY plane). A reference point 1402 may be chosen for area 1400 as a center point or other significant point upon which locations of the objects of area 1400 may be compared (e.g., a corner point).

Points 1404 and 1406 are shown in area 1400 and may represent devices, cameras, or other objects within area 1400. According to one exemplary embodiment, point 1404 may be represented by XY coordinates relative to reference point 1402. According to another exemplary embodiment, point 1404 may be represented by the distance 1403 between point 1404 and reference point 1402, and angle 1405 (the angle between the x axis and the line with the endpoints of points 1402 and 1404).

According to one exemplary embodiment, distance 1403 and angle 1405 may be stored in a standard relational database (e.g., a database similar to table 1300 of FIG. 13). As one example, the following SQL statement may be used to create a table to store location information:

CREATE TABLE LOCATION (id INTEGER NOT NULL, distance float, angle float);

An ID may be used to identify the spatial relation, and distance 1403 between points 1402 and 1404 and associated angle 1405 may be stored in the table as location information.

Referring also to FIG. 14B, point 1404 is shown in a region A. Using the measurement of angle 1405, the system can determine the region A-H (e.g., quadrant) in which point 1404 is located. Points can be classified, stored, sorted, searched and/or accessed based on the region to which a point belongs. For example, a user may search for objects (points) by region instead of by other location properties. For example, region A may be defined as a region to the north-northeast of reference point 1402, and a user or the system may search for all objects in the region if desired.

Referring further to FIG. 14B, the regions A-H may be further broken down based on distance from reference point 1402. For example, radius areas 1-3 can be used to describe device location. Point 1404 is shown in radius area 2 of region A. Therefore, point 1404 may be defined as being in region A-2, for example, and the device associated with point 1404 may be stored with “A-2” in a table. Such definitions may allow for a user to refine a search for a point. According to one exemplary embodiment, the search may include searching adjacent regions for nearby areas and/or devices (e.g., regions A-1, A-3, B-2, and H-2 may be used to search for “nearby” objects). Spatial relation functions may be modified to account for this method of location storage.

Referring back to FIGS. 14A-D, region 1407 is shown around point 1404. Region 1407 may represent an entire area surrounding point 1404 for a given radius. According to one exemplary embodiment, a query may be submitted to find all points within region 1407 (e.g., all points “near” object 1404). The query to find all points within region 1407 may be received (e.g., such a query may return point 1406 as a result). If all points in the system are stored with distance from reference point and angle pairs as described with reference to the above SQL “CREATE TABLE LOCATION” command, process 1450 shown in FIG. 14D may be used to complete the query.

A distance between reference point 1402 and a point 1414 is defined as the longest distance within the search boundary (the distance from point 1402 to point 1404, plus the search radius) (step 1452) and the distance between reference point 1402 and a point 1412 is defined as the shortest distance within the search boundary (step 1454). All points with a distance from the reference point between the longest distance and the shortest distance may then be found and/or filtered (step 1456) (e.g., only points meeting this criteria are considered in subsequent steps).

Process 1450 is further shown to include defining tangent lines to assist with filtering and/or finding the points having a proper distance from reference point 1402 and having proper lateral distance from point 1404 (step 1458). The tangent lines can be defined by finding the lines tangent to the sides of the circumference of region 1407 and intersecting reference point 1402. The tangent lines are illustrated as being tangent to the circumference of region 1407 at points 1408 and 1410.

The bounding angles for searching can then be defined as [(θ−θ′), . . . , 2*(θ−θ′)], where θ is angle 1405 and θ′ is the angle between the x-axis and the lower tangent line (the tangent line including point 1408). Angle 1420 represents the smallest angle value for which a point is still bounded by region 1407 based on the bounding angles, and angle 1422 represents the largest angle value for which a point is still bounded by region 1407 based on the bounding angles. All points found in step 1456 may be filtered or selected again, using the bounding angles to find all points that are within region 1407 (step 1460).

The distance data may be stored in a variety of manners. For example, using process 1450, all points (e.g., distance and angle pairs) within a certain range of another point may be stored together in a table (e.g., all points “near” point 1404 may be stored in a single table). According to one exemplary embodiment, distance data from a reference point may be sorted in the table. Such sorting allows a binary search instead of a linear search to be executed, cutting search costs.

While the exemplary embodiments illustrated in the figures and described herein are presently preferred, it should be understood that the embodiments are offered by way of example only. Accordingly, the present application is not limited to a particular embodiment, but extends to various modifications that nevertheless fall within the scope of the appended claims.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. All such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

It should be noted that although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A system for processing user input received at a graphical user interface to configure a building device, comprising:
a processor; and
a first memory unit communicably coupled to the processor and comprising:
computer code for processing data relating to a floor plan;
computer code for generating a graphical user interface, the graphical user interface including a representation of the floor plan;
computer code for positioning an indicator relative to the graphical representation of the floor plan based on the user input, the indicator representing the building device; and
computer code for configuring the building device based on the position of the indicator relative to the graphical representation of the floor plan.

2. The system of claim 1, further comprising:
memory for storing the floor plan data;
wherein the computer code for processing the data relating to the floor plan is configured to translate the floor plan data into normalized layout data; and
wherein the computer code for generating the graphical user interface is configured to use the normalized layout data to generate the representation of the floor plan.

3. The system of claim 2, wherein the computer code for configuring the building device is configured to generate a normalized location of the building device relative to the normalized layout data.

4. The system of claim 3, wherein the first memory unit further comprises:
computer code for determining a spatial relationship between boundaries of a building area described by the normalized layout data and defined boundaries of the building device.

5. The system of claim 1, wherein the first memory unit further comprise:
computer code for determining a spatial relationship between the building device and another building device; and
computer code for using the spatial relationship determination to make a false alarm determination.

6. The system of claim 4, wherein the defined boundaries of the building device correspond to one of the shape of a bounding contour surrounding the indicator and the shape of the indicator.

7. The system of claim 1, wherein the first memory unit further comprises:
computer code for determining a spatial relationship between boundaries of a building area described by the normalized layout data and a normalized point, a line, or a point and a line describing the building device.

8. The system of claim 1, wherein the first memory unit further comprises:
computer code for determining a spatial relationship between boundaries of the representation of the floor plan and a point, a line, or a point and a line of the indicator.

9. The system of claim 1, further comprising:
memory for storing configuration data relating to the building device;
wherein the first memory unit further comprises computer code for creating a record of the building device in the memory for storing the configuration data and updating the record based on the configuration of the building device.

10. The system of claim 1, further comprising:
a communications interface configured to send data to one of a building automation system, a security system, and a fire system; and
wherein the first memory unit further comprises computer code for sending data relating to the configuration of the building device via the communications interface to the one of the building automation system, the security system, and the fire system.

11. The system of claim 1, wherein the computer code for configuring the building device based on the position of the indicator relative to the graphical representation of the floor plan is configured to update at least one variable stored in memory of a supervisory controller configured to control the building device.

12. The system of claim 1, wherein the computer code for configuring the building device based on the position of the indicator relative to the graphical representation of the floor plan is configured to update at least one variable stored in the building device.

13. A system for processing user input received at a graphical user interface to configure a building device of a building system, the building system including a supervisory controller for the building device, the supervisory controller including a memory unit, the graphical user interface including a graphical representation of a building area and a graphical representation of the building device, comprising:
a processing circuit configured to receive the user input and to analyze the spatial relationship between the graphical representation of the building area and the graphical representation of the building device, the processing circuit further configured to cause the update of data stored in the memory unit of the supervisory controller and relating to the building device based on the spatial relationship analysis.

14. The system of claim 13, wherein the processing circuit is configured to update a name value for the building device stored in the memory unit of the supervisory controller for the building device based on the spatial relationship analysis.

15. The system of claim 14, wherein the spatial relationship analysis includes a determination of whether the building device is one of inside the building area, meeting the building area, overlapping the building area, or nearby the building area.

16. The system of claim 13, wherein the spatial relationship analysis includes analyzing a polygon associated with the graphical representation of the building device, and wherein the processing circuit is further configured to use the spatial relationship analysis to estimate whether an alarm signal received from the building device is a false alarm.

17. The system of claim 13, wherein the building device is a camera and wherein the processing circuit is further configured to generate a polygon representative of a field of view for the camera, and wherein the processing circuit is further configured to determine a relationship between another building device and the camera based on the polygon representative of the field of view for the camera.

18. A method for processing user input received at a graphical user interface and for configuring a building device of a building system, the method comprising:
processing data relating to a floor plan;
generating the graphical user interface, the graphical user interface including a representation of the floor plan;
receiving the user input;
positioning an indicator relative to the graphical representation of the floor plan based on the user input, the indicator representing the building device; and
configuring the building device based on the position of the indicator relative to the graphical representation of the floor plan.

19. The method of claim 18, wherein the data relating to the floor plan is data of a computer-aided design file for the floor plan and wherein processing the data relating to the floor plan includes translating the computer-aided design file into normalized layout data and wherein the graphical representation of the floor plan is generated using the normalized layout data.

20. The method of claim 19, further comprising:
assigning a bounding contour in the form of a polygon to the indicator; and
using a processing circuit and a computer-based description of the bounding contour to determine a spatial relationship between the description of the building contour to the normalized layout data;
wherein configuring the building device based on the position of the indicator relative to the graphical representation of the floor plan comprises using the spatial relationship to conduct one of:
(a) naming the building device and storing the name in a memory unit;
(b) relating the building device to another building device and storing the relationship in the memory unit; and
(c) relating the building device to a building area and storing the relationship in the memory unit.

21. The method of claim 19, further comprising:
assigning a bounding contour in the form of a polygon to the indicator; and
using a processing circuit and a computer-based description of the bounding contour to determine a spatial relationship between the description of the building contour to the normalized layout data;
relating the building device to another building device and storing the relationship in the memory unit; and
making a decision regarding the building device during normal use, the decision based on the stored relationship.

22. The method of claim 19, wherein the decision is a decision as to whether an alarm signal received from the building device is a false alarm.

23. A machine-readable medium for programming a computer to process user input received at a graphical user interface and for configuring a building device of a building system, the medium comprising:
processor executable instructions for:
processing data relating to a floor plan;
generating the graphical user interface, the graphical user interface including a representation of the floor plan;
receiving the user input;
positioning an indicator relative to the graphical representation of the floor plan based on the user input, the indicator representing the building device; and
configuring the building device based on the position of the indicator relative to the graphical representation of the floor plan.

24. A processing circuit configured to electronically transmit processor executable instructions via a communications interface, the processor executable instructions for:
processing data relating to a floor plan;
generating a graphical user interface, the graphical user interface including a representation of the floor plan;
receiving the user input;
positioning an indicator relative to the representation of the floor plan based on the user input, the indicator representing a building device; and
configuring the building device based on the position of the indicator relative to the representation of the floor plan.
